(19) United States
(12) Patent Application Publication
(10) Pub. No.: US 2025/0332560 A1
(43) Pub. Date: Oct. 30, 2025

(54) SYSTEM HAVING A PISTON FEEDSTOCK FEEDER SYSTEM FOR USE IN HYDROPROCESSING A SOLID FEEDSTOCK

(71) Applicant: SHELL USA, INC., Houston, TX (US)

(72) Inventors: Thomas Koch, Vordingborg (DK); Steffen JANCKER, Hamburg (DE); Gerhard Johan VAN ELBURG, Amsterdam (NL); Zhong Xin CHEN, Beijing (CN)

(21) Appl. No.: 18/866,508

(22) PCT Filed: May 31, 2023
(86) PCT No.: PCT/US2023/067678

§ 371 Date: Nov. 15, 2024

Related U.S. Application Data
(60) Provisional application No. 63/347,629, filed on Jun. 1, 2022.

(51) Int. Cl. B01J 8/00; B01J 8/24; C10G 1/08; F04B 15/02; F04B 53/14

(52) U.S. Cl. CPC B01J 8/002; B01J 8/24; C10G 1/08; F04B 15/02; F04B 53/143; B01J 2208/00752; C10G 2300/1011

(57) ABSTRACT

A system for hydroprocessing of a solid feedstock includes a solid feedstock feeding system disposed upstream from a hydropyrolysis reactor. The solid feedstock feeding system includes a piston feeder having an inlet, an outlet, at least one piston disposed between the inlet and the outlet, the at least one piston includes a chamber and a barrel disposed in and translocates within the chamber, the barrel includes a terminal end having a seal, and the seal includes an annular ring having a first wall and a second wall, the second wall is orthogonal to and extends from the first wall such that a first portion of the first wall protrudes away from the second wall in a first direction and a second portion of the first wall protrudes away from the second wall in a second direction.

The present disclosure generally relates to systems and methods for hydroprocessing of renewable feedstocks. More specifically, the present disclosure relates to a solid feedstock feeder system integrated into a hydroprocessing system.

### BACKGROUND OF THE DISCLOSURE

The demand for energy is increasing as a result of worldwide economic growth and development. This increase in the demand for energy has contributed to an increase in the amount of greenhouse gases and the overall carbon footprint. In addition, with increasing demand for liquid transportation fuels, decreasing reserves of crude petroleum oil that may be accessed and recovered easily and increasing constraints on carbon footprints of such fuels, it may be desirable to develop routes to produce liquid transportation fuels from renewable resources in an efficient manner. Such liquid transportation fuels produced from biomass are sometimes also referred to as biofuels. Biomass offers a source of renewable carbon. Examples of suitable biomass include vegetable oils, oils obtained from algae and animal fats, deconstruction materials such as pyrolyzed recyclable materials and wood, among others. Therefore, when using fuels derived from renewable resources, it may be possible to achieve more sustainable CO₂ emissions over petroleum-derived fuels. For biofuels to replace all or at least a portion of the carbon-based fossil fuels, the biofuels should meet the required performance and emission specifications of the carbon-based fossil fuels.

Currently, solid feedstock (e.g., solid biomass) is feed into a hydroprocessing reactor by pressurizing a volume of the solid feedstock in, for example, a lock hopper system. While this approach is suitable for introducing the solid feedstock into the reactor, it requires a large vessel and consumes an undesirable amount of pressurized gas. In addition, existing lock hopper systems have a complex design. For example, the lock hopper system includes an atmospheric vessel, a sluice vessel, and a pressurized vessel along with several sets of valves. Moreover, because lock hopper systems pressurize the volume of the solid feedstock, a source of pressurized gas is required. It would be advantageous to use a solid feedstock feeding system that does not require the use of large amounts of pressurized gas and has a simpler design compared to existing lock hopper systems.

### SUMMARY

In an embodiment, a system for hydroprocessing of a solid feedstock includes a hydropyrolysis reactor having one or more inlets that may receive the solid feedstock and to generate a product stream having partially deoxygenated hydropyrolysis product, H₂O, H₂, CO₂, CO, C₁-C₃ gases, char, and fines. The hydropyrolysis reactor includes one or more deoxygenation catalysts. The system also includes a solid feedstock feeding system disposed upstream from and fluidly coupled to the hydropyrolysis reactor. The solid feedstock feeding system includes a piston feeder having an inlet, an outlet, at least one piston disposed between the inlet and the outlet, the at least one piston includes a chamber and a barrel disposed in and that may translocate within the chamber, the barrel includes a terminal end having a seal, and the seal includes an annular ring having a first wall and a second wall, the second wall is orthogonal to and extends from the first wall such that a first portion of the first wall protrudes away from the second wall in a first direction and a second portion of the first wall protrudes away from the second wall in a second direction that is substantially opposite from the first direction.

In another embodiment, a system for hydroprocessing of a solid feedstock includes a hydropyrolysis reactor having one or more inlets that may receive the solid feedstock and that may generate a product stream having partially deoxygenated hydropyrolysis product, H₂O, H₂, CO₂, CO, C₁-C₃ gases, char, and fines. The system also includes a hydroconversion reactor disposed downstream from and fluidly coupled to the hydropyrolysis reactor. The hydroconversion reactor may receive the product stream, the partially deoxygenated hydropyrolysis product in the product stream undergoes hydroconversion in the hydroconversion reactor to generate a vapour phase product having substantially fully deoxygenated hydrocarbon product, H₂O, CO, CO₂, and C₁-C₃ gases. The system also includes a solid feedstock feeding system disposed upstream from and fluidly coupled to the hydropyrolysis reactor. The solid feedstock feeding system includes a piston feeder having an inlet, an outlet, at least one piston disposed between the inlet and the outlet, the at least one piston has a barrel disposed in and that may translocate within a chamber and having a seal on a terminal end, the seal has an annular ring having a T-shaped cross-sectional geometry.

Additional features and advantages of exemplary implementations of the disclosure will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

Advantages of the disclosure may become apparent upon reading the following detailed description and upon reference to the drawings in which:

FIG. 1 is a block diagram of a hydroprocessing system having a first stage and a second stage used to produce hydrocarbons from biomass, whereby the system includes a solid feedstock feeding system having a piston feeder and a dosing tank, in accordance with an embodiment of the present disclosure;

FIG. 2 is a diagram of the solid feedstock feeding system of FIG. 1, whereby the piston feeder includes various pistons, in accordance with an embodiment of the present disclosure;

FIG. 3 is a diagram of a piston feeder that may be used in the solid feedstock feeding system of FIG. 2, whereby the piston feeder includes a piston in a slanted configuration, in accordance with an embodiment of the present disclosure;

FIG. 4 is a perspective view of the components that make up a terminal end of a piston associated with the piston feeder of FIGS. 2 and 3, in accordance with an embodiment of the present disclosure;

FIG. 5 is a perspective view of the components of the terminal end of a piston associated with the piston feeder of FIGS. 2 and 3, in accordance with an embodiment of the present disclosure;

FIG. 6 is a perspective view of a terminal end of a piston associated with the piston feeder of FIGS. 2 and 3, in accordance with an embodiment of the present disclosure;

FIG. 7 is a cross-sectional view of the terminal end of the piston in FIG. 6 along line 7-7, in accordance with an embodiment of the present disclosure;

FIG. 8 is an exploded cross-sectional view of a portion of the terminal end of the piston in FIG. 7, in accordance with an embodiment of the present disclosure;

FIG. 9 is a cross-sectional view of the terminal end of a piston within a chamber of the piston feeder of FIGS. 2 and 3, in accordance with an embodiment of the present disclosure;

FIG. 10 is a cross-sectional view of the terminal end of the piston within a chamber of the piston feeder of FIGS. 2 and 3, whereby the terminal end includes a spring, in accordance with an embodiment of the present disclosure;

FIG. 11 is a cross-sectional view of the terminal end of the piston within a chamber of the piston feeder of FIGS. 2 and 3, whereby the terminal end includes a pressure assisted seat, in accordance with an embodiment of the present disclosure;

FIG. 12 is a cross-sectional view of the dosing tank of the solid feedstock feeding system of FIG. 2, whereby the dosing tank includes agitators and solid transport devices to move the solid feedstock, in accordance with an embodiment of the present disclosure;

FIG. 13 is flow diagram of a method for using the piston feeder of FIGS. 2 and 3 to provide a solid feedstock to the dosing tank, in accordance with an embodiment of the present disclosure;

FIG. 14 is a cross-sectional view of the piston feeder of FIG. 2, whereby a first chamber and a second chamber are in fluid communication and isolated from an outlet of the piston feeder, in accordance with an embodiment of the present disclosure;

FIG. 15 is a cross-section view of the piston feeder of FIG. 2, whereby the solid feedstock has been fed to the second chamber and the outlet is isolated from the second chamber, in accordance with an embodiment of the present disclosure;

FIG. 16 is a cross-sectional view of the piston feeder of FIG. 2, whereby the second chamber having the solid feedstock is isolated from a first chamber and the outlet, in accordance with an embodiment of the present disclosure;

FIG. 17 is a cross-sectional view of the piston feeder of FIG. 2, whereby the second chamber having the solid feedstock is in fluid communication with the outlet and isolated from the first chamber, in accordance with an embodiment of the present disclosure; and

FIG. 18 is a cross-sectional view of the piston feeder of FIG. 2, whereby a feed chamber is aligned with an inlet, and the second chamber and the outlet are isolated from the first chamber and the feed chamber, in accordance with an embodiment of the present disclosure; and

FIG. 19 is plot of the number of cycles as a function of leak flow for the piston feeder, in accordance with an embodiment of the present disclosure.

### DETAILED DESCRIPTION

One or more specific embodiments of the present disclosure will be described below. These described embodiments are examples of the presently disclosed techniques. Additionally, in an effort to provide a concise description of these embodiments, not all features of an actual implementation may be described in the specification. It should be appreciated that in the development of any such actual implementation, as in any engineering or design project, numerous implementation-specific decisions will be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

The terms “approximately,” “about,” and “substantially” as used herein represent an amount close to the stated amount that still performs a desired function or achieves a desired result. For example, the terms “approximately,” “about,” and “substantially” may refer to an amount that is within less than 10% of, within less than 5% of, within less than 1% of, within less than 0.1% of, and within less than 0.01% of a stated amount.

As discussed in further detail below, the disclosed embodiments include a piston feeder system that may be used to provide solid feedstock (e.g., biomass) to a hydroprocessing reactor (e.g., a hydropyrolysis reactor). Hydroprocessing is a catalytic process that includes hydropyrolysis, hydroconversion and/or hydrotreating of certain carbon-containing materials to generate hydrocarbon fuels. Carbon-containing materials that may be used to generate hydrocarbon fuels via hydroprocessing include solid feedstocks from renewable resources such as, for example, biomass and waste plastics, among others. Certain existing hydroprocessing systems use a lock hopper to provide solid feedstock (e.g., biomass) to a hydropyrolysis reactor. Lock hoppers generally require the use of multiple vessels for storing, transferring, and discharging/blowing the solid feedstock into the hydropyrolysis reactor. One problem with existing lock hoppers is that, when the solid biomass falls into each vessel, the solid biomass is compacted. For example, certain lock hopper configurations have a storage tank that supplies the solid feedstock to a transfer vessel that is pressurized after having received the solid feedstock from the storage tank. As the solid feedstock falls from the storage tank into the transfer vessel, the solid feedstock gets compacted. Compacting of the solid feedstock in the transfer vessel results in lumps or clusters of solid feedstock, which impact the operation of the hydropyrolysis reactor and the efficiency of the hydroprocessing process. For example, a lump or cluster of solid feedstock has substantially less surface area then the total surface area of the solid feedstock parts forming the lump or cluster; which may hinder the process efficiency. In addition, feedstock lumps or clusters will make the feeding operation unreliable due to bridging and blocking of the feed flow path by the lumps or clusters. Operation of the hydropyrolysis reactor is impacted as a result of the unstable and unreliable feeding as well as forming of solid tar lumps within the adjacent feeding system to the hydropyrolysis reactor (e.g., when using solid biomass to generate biofuels). Therefore, it is desirable to develop a solid feedstock feeding system that may provide industrial-scale volumes of solid feedstock to a hydropyrolysis reactor in a manner that does result in compaction of the feedstock,

Moreover, the lock hopper feeding systems used in industrial-scale applications are based on batch-wise transportation of volumes of solid feedstock through the lock hopper vessels to the reactors, thereby the vessels used in the lock hopper feeding systems are generally large (e.g., typically holding volumes in the order of 50-80 cubic meters (m³)). As such, the amount of pressurized gas (e.g., approximately 5000 kilogram/hour (kg/hr)) used to transfer the required volume of the solid feedstock into the reactor may be undesirable. For example, the amount of pressurized gas required may impact the efficiency of the process due, in part, to the amount of energy used to pressurize the gas. Accordingly, it would be advantageous to develop a solid feedstock feeding system that does not require or uses a small amount of pressurized gas, and has a smaller/compact configuration that mitigates compaction of the solid feedstock compared to existing lock hopper feeding systems. It has been recognized that a piston feeder may be used to feed solid feedstock into a hydropyrolysis reactor at an industrial scale while mitigating the undesirable compacting, vessel size, and pressurized gas quantity associated with lock hopper feeding systems.

Piston feeders generally use o-rings to seal and maintain pressure within its chambers (i.e. cylinders). However, over time, forces exerted on the o-rings from the reciprocating motion of the piston may result in creep and eventually damage to the o-ring such that the seal and the desired pressure within a respective chamber of the piston feeder is not maintained. Therefore, it may be advantageous to provide a piston feeder and seal that mitigate the problems associated with existing feedstock feeding systems. Disclosed herein is a piston feeder system having an improved seal for delivering a solid feedstock to hydropyrolysis reactor in a manner that maintains a desired pressure in respective chambers and does not rely on pressurized gas nor results in compaction of the solid feedstock.

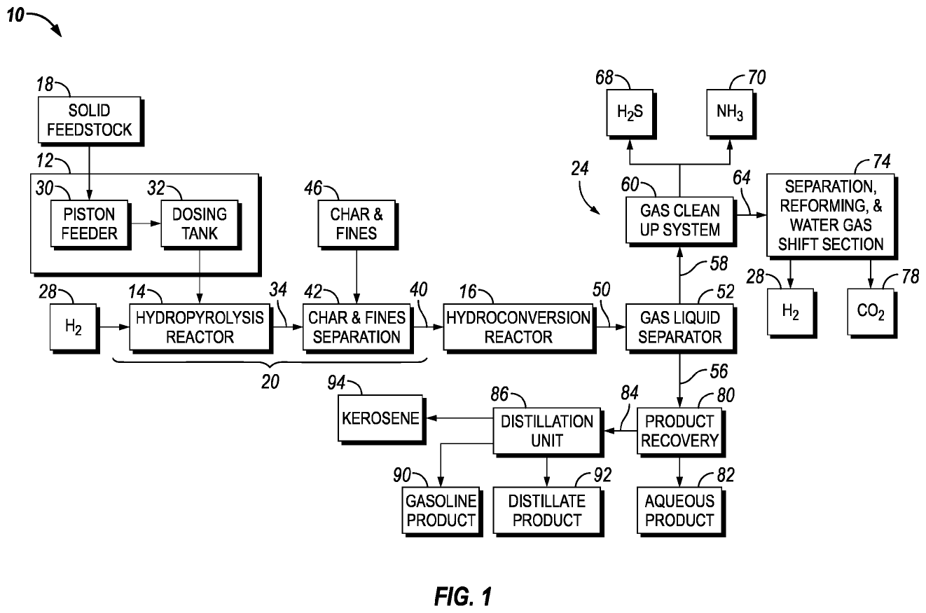

With the foregoing in mind, FIG. 1 is a block diagram of an embodiment of a system 10 that may include the disclosed piston feeder for providing a solid feedstock (e.g., biomass and/or waste plastics/oils) to a reactor (e.g., a hydropyrolysis reactor) used in a hydroprocessing process that generates a biofuel. As should be appreciated, solid feedstock-derived hydrocarbon products disclosed herein may be generated by any suitable hydroprocessing technique such as those disclosed in U.S. Pat. No. 9,447,328, which is hereby incorporated by reference in its entirety. In the illustrated embodiment, the system 10 includes a solid feedstock feeding system 12, a hydropyrolysis reactor 14 positioned downstream from and fluidly coupled to the solid feedstock feeding system 12, and a hydroconversion reactor 16 positioned downstream from and fluidly coupled to the hydropyrolysis reactor 14. As discussed in further detail below, the reactors 14, 16 are used to convert a solid feedstock 18 into an intermediate hydrocarbon fuel fraction (e.g., a GO/diesel fraction) that may be used to generate a commercially viable biodiesel. As illustrated, the reactors 14, 16 are disposed within one of two stages. For example, the system 10 includes a first stage 20 and a second stage 24. The first stage 20 includes the hydropyrolysis reactor 14, and the second stage 24 includes the hydroconversion reactor 16. The reaction pressure in the first stage 20 and the second stage 22 may be varied to tailor the boiling point distribution and composition of the resultant hydrocarbon product(s) generated by the second stage 24. The ability to tailor the boiling point distribution and/or composition of the resultant hydrocarbon product by varying the reaction pressure may provide an efficient process for generating commercially viable hydrocarbon biofuels that meet the different requirements set forth by the location and/or market in which the hydrocarbon biofuel will be used. For example, when the reaction pressure is less than approximately 0.6 megapascals (MPa) the occurrence of undesirable olefin and/or aromatic saturation reactions may be decreased and cetane numbers for biodiesel and/or gasoline fractions may be increased compared to reaction pressures above 2.0 MPa. However, the cetane numbers may still not be at a desired level to meet specifications set forth for commercial biodiesel fuels. Therefore, the biodiesel fraction may need to undergo additional processing (e.g., hydropolishing) to upgrade the biodiesel and increase the cetane number above approximately 50. Therefore, in certain embodiments, the hydroprocessing system may include a third stage downstream of the second stage 24 where one or more the biodiesel fraction(s) undergo additional processing.

### First Stage

In the illustrated embodiment, the solid feedstock 18 having biomass (e.g., lignocellulose) and/or waste plastics and molecular hydrogen (H₂) 28 are introduced into the hydropyrolysis reactor 14. For example, the solid feedstock 18 is fed to a piston feeder 30 of the solid feedstock feeding system 12. As described in further detail below, the piston feeder 30 does not require the use of a pressurized gas and various vessels as in existing lock hopper feeding systems. Moreover, the piston feeder 30 has vessels (e.g., chambers or cylinders) for receiving and transferring the solid feedstock 18 that are between approximately 35% and 75% smaller than the vessels used in existing lock hopper feeding systems. The solid feedstock feeding system 12 also includes a dosing tank 32 downstream from and fluidly coupled to the piston feeder 30 and the hydropyrolysis reactor 14. The configuration of the piston feeder 30 and the dosing tank 32 mitigate compacting of the solid feedstock 18 in the solid feedstock feeding system 12. While in the illustrated embodiment, the system 10 has a single hydropyrolysis reactor 14, it should be appreciated that the system 10 may have multiple hydropyrolysis reactors 14. In embodiments, in which the system 10 includes multiple hydropyrolysis reactors 14, the dosing tank 32 is fluidly coupled to and provides the solid feedstock 18 to each of the reactors 14.

The hydropyrolysis reactor 14 contains a deoxygenation catalyst that facilitates partial deoxygenation of the solid feedstock 18. For example, in the hydropyrolysis reactor 14, the solid feedstock 18 undergoes hydropyrolysis, producing an output 34 having char, partially deoxygenated products of hydropyrolysis, light gases (C₁-C₃ gases, carbon monoxide (CO), carbon dioxide (CO₂), and H₂), water (H₂O) vapor and catalyst fines. The hydropyrolysis reactor 14 may be a fluidized bed reactor (e.g., a fluidized bubbling bed reactor), fixed-bed reactor, or any other suitable reactor. In embodiments in which the hydropyrolysis reactor 14 is a fluidized bed reactor, the fluidization velocity, catalyst particle size and bulk density and solid feedstock particle size and bulk density are selected such that the deoxygenation catalyst remains in the bubbling fluidized bed, while the char produced is entrained with the partially deoxygenated products (e.g., the output 30) exiting the hydropyrolysis reactor 14. The hydropyrolysis step in the first stage 20 employs a rapid heat up of the solid feedstock 18 such that a residence time of the pyrolysis vapors in the hydropyrolysis reactor 14 is preferably less than approximately 1 minute, more preferably less than approximately 30 seconds and most preferably less than approximately 10 seconds.

The solid feedstock 18 used in the disclosed process may include a residual waste feedstock and/or a biomass feedstock containing lignin, lignocellulosic, cellulosic, hemicellulosic material, or any combination thereof. Lignocellulosic material may include a mixture of lignin, cellulose and hemicelluloses in any proportion and also contains ash and moisture. Such material is more difficult to convert into fungible liquid hydrocarbon products than cellulosic and hemicellulosic material. It is an advantage of the present process that it can be used for lignocellulose-containing biomass. Suitable lignocellulose-containing biomass includes woody biomass and agricultural and forestry products and residues (whole harvest energy crops, round wood, forest slash, bamboo, sawdust, bagasse, sugarcane tops and trash, cotton stalks, corn stover, corn cobs, castor stalks, Jatropha whole harvest, Jatropha trimmings, de-oiled cakes of palm, castor and Jatropha, coconut shells, residues derived from edible nut, rice husk, rice straw production and mixtures thereof), animal waste and municipal solid wastes containing lignocellulosic material. The municipal solid waste (MSW) may include any combination of lignocellulosic material (yard trimmings, pressure-treated wood such as fence posts, plywood), discarded paper and cardboard and waste plastics, along with refractories such as glass, metal. Prior to use in the process disclosed herein, municipal solid waste may be optionally converted into pellet or briquette form. The pellets or briquettes are commonly referred to as Refuse Derived Fuel in the industry. Certain feedstocks (such as algae and lemna) may also contain protein and lipids in addition to lignocellulose. Residual waste feedstocks are those having mainly waste plastics. In certain embodiments, the solid feedstock 18 may be different ranks of coal, peat or any other suitable solid feedstock that may be fed to a pressurized reactor.

The solid feedstock 18 may be provided to the hydropyrolysis reactor 14 in the form of loose biomass particles having a majority of particles preferably less than about 3.5 millimeters (mm) in size or in the form of a biomass/liquid slurry. However, as appreciated by those skilled in the art, the solid feedstock 18 may be pre-treated or otherwise processed in a manner such that larger particle sizes may be accommodated. Suitable means for introducing the solid feedstock 18 into the hydropyrolysis reactor 14 include, but are not limited to, an auger, fast-moving (greater than about 5 minutes (m)/second (sec)) stream of carrier gas (such as inert gases and H₂), and constant-displacement pumps, impellers, turbine pumps or the like. In an embodiment of the present disclosure, a double-screw system having a slow screw for metering the solid feedstock 18 followed by a fast screw to push the solid feedstock 18 into the reactor without causing torrefaction in the screw housing is used for dosing. An inert gas or hydrogen flow is maintained over the fast screw to further reduce the residence time of the solid feedstock 18 in the fast screw housing.

The hydropyrolysis step is carried out in the hydropyrolysis reactor 14 at a temperature in the range of from approximately 300 Celsius (° C.) to approximately 650° C., preferably in the range of from approximately 330° C. to approximately 500° C., more preferably in the range of from approximately 350° C. to approximately 480° C., and a pressure in the range of from approximately 0.50 megapascal (MPa) to approximately 7.5 MPa (approximately 5-75 bar). The heating rate of the solid feedstock 18 is preferably greater than about 100 watts/meter² (W/m²). The weight hourly space velocity (WHSV) in grams (g) biomass/g catalyst/hour (h) for the hydropyrolysis step is in the range of from approximately 0.2 h⁻¹ to approximately 10 h⁻¹, preferably in the range of from approximately 0.3 h⁻¹ to 3 h⁻¹.

The temperatures used in hydropyrolysis rapidly devolatilize the solid feedstock 18. Thus, in a preferred embodiment, the hydropyrolysis step includes the use of an active catalyst (e.g., a deoxygenation catalyst) to stabilize the hydropyrolysis vapors. The activity of the catalyst used herein remains high and stable over a long period of time such that it does not rapidly coke. Catalyst particle sizes, for use in the hydropyrolysis reactor 14, are preferably in the range of from approximately 0.3 millimeter (mm) to approximately 4.0 mm, more preferably in the range of from approximately 0.6 mm to approximately 3.0 mm, and most preferably in the range of from approximately 1 mm to approximately 2.4 mm.

Any deoxygenation catalyst suitable for use in the temperature range of the hydropyrolysis process may be used. Preferably, the deoxygenation catalyst is selected from sulfided catalysts having one or more metals from the group consisting of nickel (Ni), cobalt (Co), molybdenum (Mo) or tungsten (W) supported on a metal oxide. Suitable metal combinations include sulfided NiMo, sulfided CoMo, sulfided NiW, sulfided CoW and sulfided ternary metal systems having any 3 metals from the family consisting of Ni, Co, Mo and W. Monometallic catalysts such as sulfided Mo, sulfided Ni and sulfided W are also suitable for use. Metal combinations for the deoxygenation catalyst used in accordance with certain embodiments of the present disclosure include sulfided NiMo and sulfided CoMo. Supports for the sulfided metal catalysts include metal oxides such as, but not limited to, alumina, silica, titania, ceria and zirconia. Binary oxides such as silica-alumina, silica-titania and ceria-zirconia may also be used. Preferably, the supports include alumina, silica and titania. In certain embodiments, the support contains recycled, regenerated and revitalized fines of spent hydrotreating catalysts (e.g., fines of CoMo on oxidic supports, NiMo on oxidic supports and fines of hydrocracking catalysts containing NiW on a mixture of oxidic carriers and zeolites). Total metal loadings on the deoxygenation catalyst are preferably in the range of from approximately 1.5 weight percent (wt %) to approximately 50 wt % expressed as a weight percentage of calcined deoxygenation catalyst in oxidic form (e.g., weight percentage of Ni (as NiO) and Mo (as MoO₃) on calcined oxidized NiMo on alumina support). Additional elements such as phosphorous (P) may be incorporated into the deoxygenation catalyst to improve the dispersion of the metal.

The first stage 20 of the process disclosed herein produces the output 30 having a partially deoxygenated hydropyrolysis product. The term “partially deoxygenated” as used herein denotes a material in which at least 30 weight % (wt %), preferably at least 50 wt %, more preferably at least 70 wt % of the oxygen present in the original solid feedstock 18 (e.g., lignocelluloses-containing biomass) has been removed. The extent of oxygen removal refers to the percentage of the oxygen in the solid feedstock 18 (e.g., biomass), excluding that contained in the free moisture in the solid feedstock 18. This oxygen is removed in the form of water (H₂O), carbon monoxide (CO) and carbon dioxide (CO₂) in the hydropyrolysis step. Although it is possible that nearly 100 wt % of the oxygen present in the solid feedstock 18 is removed, generally at most 99 wt %, suitably at most 95 wt % will be removed in the hydropyrolysis step.

### Char Removal

As discussed above, the output 30 produced from the hydropyrolysis step in the hydropyrolysis reactor 14 includes a mixed solid and vapor product that includes char, ash, catalyst fines, partially deoxygenated hydropyrolysis product, light gases (C₁-C₃ gases, CO, CO₂, hydrogen sulfide (H₂S), ammonia (NH₃) and H₂), H₂O vapor, vapors of C₄₊ hydrocarbons and oxygenated hydrocarbons. Char, ash, and catalyst fines are entrained with the vapor phase product. Therefore, between the hydropyrolysis and hydroconversion steps, the first stage 20 and the second stage 24, respectively, char and catalyst fines are removed from the vapor phase product (e.g., the partially deoxygenated hydropyrolysis product). Any ash present may also be removed at this stage.

In certain embodiments, the hydropyrolysis reactor 14 may include solid separation equipment (e.g., cyclones), for example above a dense bed phase, to mitigate the entrainment of solid particles above a certain particle size. In addition, or alternatively, the solid separation equipment may be positioned downstream from the hydropyrolysis reactor 14 that removes the char and other solids in the output 30 to generate a vapor phase product 40. For example, as illustrated in FIG. 1, the output 30 is fed to a solid separator 42 that separates/removes the solids (e.g., char, ash, and catalyst fines 46) from the output 34. The char and catalyst fines 46 may be removed from the output 34 by cyclone separation, swirl separator, filtering, electrostatic precipitation, inertial separation, magnetic separation, or any other suitable solid separation technique and combinations thereof. For example, char may be removed by filtration from the vapor stream (e.g., the output 30) or by way of filtering from a wash step-ebullated bed. Back pulsing may be employed in removing char and other solids from the filters as long as hydrogen used in the disclosed process sufficiently reduces the reactivity of the pyrolysis vapors and renders the char free-flowing.

In one embodiment, the solid separator 42 includes one or more cyclones. In certain embodiments, the solid separator 42 includes a candle filter (e.g., a blow back candle filter). The candle filter receives the output 34 from the hydropyrolysis reactor 14 and separates the char and catalyst fines 46 the output 34 at a removal efficiency of at least 99% to generate the vapor phase product 40. In other embodiments, the solid separator 36 includes one or more filters or a combination of cyclones, filters, and other suitable solid separation equipment to remove the entrained solids from the output 30. For example, the char 38 and other solids may be removed by cyclone separation followed by hot gas filtration. The hot gas filtration removes fines not removed in the cyclones. In this embodiment, the dust cake caught on the filters is more easily cleaned compared to the char removed in the hot filtration of the aerosols produced in conventional fast pyrolysis because the hydrogen from the hydropyrolysis step stabilizes the free radicals and saturated the olefins. In accordance with another embodiment of the present disclosure, cyclone separation followed by trapping the char and catalyst fines 46 in a high-porosity solid adsorbent bed is used to remove the char and catalyst fines 46 from the output 34. By way of non-limiting example, high-porosity solid adsorbents suitable for trapping the char and catalyst fines 46 include alumina silicate materials. Inert graded bed and/or filter materials may also be used to remove the char and catalyst fines 46 from the output 34 to generate the vapour phase product 40.

In other embodiments, the solid separator 40 includes a combination of cyclones and swirl tube separators. In this particular embodiment, the cyclone receives the output 34 from the hydropyrolysis reactor 14 to generate an intermediate product having a reduced char and catalyst fines content compared to the output 34. The intermediate product is fed to a swirl tube separator downstream of the cyclones to remove additional char and catalyst fines not removed by the cyclones, thereby generating the vapor phase product 40 and the char and catalyst fines 46. The combined cyclone and swirl tube separators of the solid separator 42 remove greater than 99.99% of the char and catalyst fines 46 from the output 34.

The char and catalyst fines 46 may also be removed by bubbling the first stage product gas (e.g., the output 34) through a re-circulating liquid. The re-circulated liquid includes a high boiling point portion of a finished oil from this process (e.g., from the second stage 24) and is thus a fully saturated (hydrogenated), stabilized oil having a boiling point above approximately 370° C. In certain embodiments, the finished oil may be a heavy oil generated in a separate process. The char or catalyst fines 46 from the first stage 20 are captured in this liquid. A portion of the liquid may be filtered to remove the fines 46 and a portion may be re-circulated back to the hydropyrolysis reactor 14. By using a re-circulating liquid, the temperature of the char-laden process vapors from the first stage 20 is lowered to a temperature suitable for the hydroconversion step in the second stage 24, while also removing fine particulates of char and catalyst. Additionally, employing liquid filtration avoids the use of hot gas filtration.

In accordance with another embodiment of the present disclosure, large-size NiMo or CoMo catalysts, deployed in an ebullated bed, are used for char removal to provide further deoxygenation simultaneous with the removal of fine particulates. Particles of this catalyst should be large, preferably in the range of from 15 to 30 mm in size, thereby rendering them easily separable from the fine char carried over from the hydropyrolysis reactor 14, which is generally less than 200 mesh (smaller than 70 micrometers (μm).

### Second Stage

Following removal of the char and catalyst fines 46, the vapor phase product 40 (e.g., the partially deoxygenated hydropyrolysis product) together with the H₂, CO, CO₂, H₂O, and C₁-C₃ gases from the hydropyrolysis step (e.g., the first stage 20) are fed into the hydroconversion reactor 16 in the second stage 24 and subjected to a hydroconversion step. The hydroconversion step is carried out at a temperature in the range of from approximately 300° C. to approximately 600° C. and a pressure in the range of from approximately 0.1 MPa to approximately 5 MPa. As should be noted, pressures higher than 0.6 MPa may be used to tailor the boiling point distribution and composition of the resultant hydrocarbon product based on the desired specifications of the hydrocarbon fuel produced by the hydroprocessing. The weight hourly space velocity (WHSV) for this step is in the range of approximately 0.1 h⁻¹ to approximately 2 h⁻¹. The hydroconversion reactor 16 is a fixed bed reactor. However, in certain embodiments, the hydroconversion reactor 16 may be a fluidized bed reactor. The vapor phase product 40 undergoes hydroconversion in the presence of a hydroconversion catalyst to generate a fully deoxygenated hydrocarbon product 50. The term “fully deoxygenated” as used herein denotes a material in which at least 98 wt %, preferably at least 99 wt %, more preferably at least 99.9 wt % of the oxygen present in the original solid feedstock 18 (e.g., lignocelluloses-containing biomass) has been removed. The hydrocarbon product 50 contains light gaseous hydrocarbons, such as methane, ethane, ethylene, propane and propylene, naphtha range hydrocarbons, middle-distillate range hydrocarbons, hydrocarbons boiling above 370° C. (based on ASTM D86), hydrogen and by-products of the hydroconversion reactions such as H₂O, H₂S, NH₃, CO and CO₂.

The solid feedstock 18 used in the disclosed processes may contain metals such as, but not limited to, sodium (Na), potassium (K), calcium (Ca) and phosphorus (P). These metals may poison the hydroconversion catalyst used in the second stage 24. However, these metals may be removed with the char and ash products (e.g., the char and catalyst fines 46) in the first stage 20. Accordingly, the hydroconversion catalyst used in the hydroconversion step is protected from Na, K, Ca, P, and other metals present in the solid feedstock 18 which may otherwise poison the hydroconversion catalyst. Moreover, by hydropyrolysis of the solid feedstock 18 in the first stage 20, the hydroconversion catalyst is advantageously protected from olefins and free radicals. The conditions under which hydropyrolysis occurs in the first stage 20 stabilize free radicals generated during high temperature devolatilization of the solid feedstock 18 (e.g., biomass) by the presence of hydrogen and catalyst, thereby generating stable hydrocarbon molecules that are less prone to, for example, coke formation reactions which may deactivate the catalyst.

The hydroconversion catalyst used in the hydroconversion step includes any suitable hydroconversion catalyst having a desired activity in the temperature range of the disclosed hydroconversion process. For example, the hydroconversion catalyst is selected from sulfided catalysts having one or more metals from the group consisting of Ni, Co, Mo, or W supported on a metal oxide. Suitable metal combinations include sulfided NiMo, sulfided CoMo, sulfided NiW, sulfided CoW and sulfided ternary metal systems having any three metals from the family consisting of Ni, Co, Mo, and W. Catalysts such as sulfided Mo, sulfided Ni and sulfided W are also suitable for use. The metal oxide supports for the sulfided metal catalysts include, but are not limited to, alumina, silica, titania, ceria, zirconia, as well as binary oxides such as silica-alumina, silica-titania, and ceria-zirconia. Preferred supports include alumina, silica, and titania. The support may optionally contain regenerated and revitalized fines of spent hydrotreating catalysts (e.g., fines of CoMo on oxidic supports, NiMo on oxidic supports and fines of hydrocracking catalysts containing NiW on a mixture of oxidic carriers and zeolites). Total metal loadings on the catalyst are in the range of from approximately 5 wt % to approximately 35 wt % (expressed as a weight percentage of calcined catalyst in oxidic form, e.g., weight percentage of nickel (as NiO) and molybdenum (as MoO₃) on calcined oxidized NiMo on alumina catalyst). Additional elements such as phosphorous (P) may be incorporated into the catalyst to improve the dispersion of the metal. Metals can be introduced on the support by impregnation or co-mulling or a combination of both techniques. The hydroconversion catalyst used in the hydroconversion step may be, in composition, the same as or different to the deoxygenation catalyst used in the hydropyrolysis step (e.g., first stage 20). In one embodiment of the present disclosure, the hydropyrolysis catalyst includes sulfided CoMo on alumina support and the hydroconversion catalyst includes sulfided NiMo on alumina support.

Following the hydroconversion step, the fully deoxygenated hydrocarbon product 42 is fed to one or more condensers that condenses the hydrocarbon product 50. The condensed hydrocarbon product 50 is fed to a gas-liquid separator 52 to provide a liquid phase product 56 having substantially fully deoxygenated C₄₊ hydrocarbon liquid and aqueous material. The term “substantially fully deoxygenated” is used herein to denote a material in which at least 90 wt % to 99 wt % of the oxygen present in the original lignocellulose containing biomass (e.g., the solid feedstock 18) has been removed. Accordingly, the resulting liquid phase product 56 (e.g., the substantially fully deoxygenated hydrocarbon C₄₊ liquid) contains less than 2 wt %, preferably less than 1 wt %, and most preferably less than 0.1 wt % oxygen. The substantially fully deoxygenated C4+ hydrocarbon liquid is compositionally different from bio-oil that is generated using other low pressure hydroprocesses. For example, the oxygen content of bio-oil is greater (e.g., between approximately 5 wt % to 15 wt %) compared to the liquid phase product 56 (e.g., less than 2 wt %). Therefore, due, in part, to the lower oxygen content of the liquid phase product 56, an amount of acid components (as measured by total acid number) and polar compounds is decreased compared to the bio-oil. By way of non-limiting example, the acid components include carboxylic acids, phenols, and mixtures thereof.

The hydrocarbon product 50 undergoes a separation process in the gas-liquid separator 52 that separates and removes the aqueous material from the substantially fully deoxygenated C₄₊ hydrocarbon liquid. Any suitable phase separation technique may be used to separate and remove the aqueous material from the substantially fully deoxygenated C₄₊ hydrocarbon liquid, thereby generating the liquid phase product 56 having the substantially fully deoxygenated C₄₊ hydrocarbon and non-condensable gases 58. The non-condensable gases 58 includes mainly H₂, CO, CO₂, and light hydrocarbon gases (typically C₁ to C₃ and may also contain some C₄₊ hydrocarbons).

In certain embodiments, the non-condensable gases 58 are fed to a gas clean-up system 60. The gas clean-up system 60 removes H₂S, NH₃ and trace amounts of organic sulfur-containing compounds, if present, as by-products of the process, thereby generating a hydrocarbon stream 64 having CO, CO₂, H₂ and the light hydrocarbon gases. The gas clean-up system 60 includes one or more process units that remove H₂S 68 and NH₃ 70 from the non-condensable gases 58 as by-products of the process. The hydrocarbon stream 64 may be sent to a separation, reforming, and water-gas shift section 74 where hydrogen 28 is produced from the light hydrocarbon gases in the hydrocarbon stream 64 and renewable CO₂ 78 is discharged as a by-product of the process. A fuel gas stream may be recovered as a by-product of this process. The produced hydrogen 28 may be re-used in the process. For example, the hydrogen 28 may be recycled to the hydropyrolysis reactor 14 in the first stage 20. Sufficient hydrogen is produced for use in the entire process disclosed herein. That is, the quantity of the hydrogen 28 produced by the separation, reforming and water-gas shift section 74 is equal to or greater than the hydrogen required to maintain fluidization and sustain chemical consumption of hydrogen in the process.

The liquid phase product 56 recovered from the gas-liquid separator 52 is fed to a product recovery section 80. In the product recovery section 80, aqueous product 82 is removed from the liquid phase product 56 to generate an intermediate liquid phase product 84. The intermediate liquid phase product 84 may undergo distillation to separate the substantially fully deoxygenated C₄₊ hydrocarbon liquid into fractions according to ranges of the boiling points of the liquid products contained in the intermediate liquid phase product 84. For example, the substantially fully deoxygenated C₄₊ hydrocarbon liquid in the intermediate liquid phase product 84 includes naphtha range hydrocarbons, middle distillate range hydrocarbons (e.g., gas oil, diesel) and vacuum gasoil (VGO) range hydrocarbons.

For the purpose of clarity, “middle distillates” as used herein are hydrocarbons or oxygenated hydrocarbons recovered by distillation between an atmospheric-equivalent initial boiling point (IBP) and a final boiling point (FBP) measured according to standard ASTM distillation methods. ASTM D86 initial boiling point of middle distillates may vary from between approximately 150° C. to approximately 220° C. Final boiling point of middle distillates, according to ASTM D86 distillation, may vary from between approximately 350° C. to approximately 380° C. “Naphtha” as used herein is one or more hydrocarbons or oxygenated hydrocarbons having four or more carbon atoms and having an atmospheric-equivalent final boiling point that is greater than approximately 90° C. but less than approximately 200° C. A small amount of hydrocarbons produced in the process (approximately less than 3 wt % of total C₄₊ hydrocarbons, and preferably less than 1 wt % of total C₄₊ hydrocarbons) boil at temperatures higher than those for the middle distillates as defined above. That is, these hydrocarbons have a boiling range similar to vacuum-gas oil produced by distillation of petroleum. Gasoline is predominantly naphtha-range hydrocarbons and is used in spark-ignition internal combustion engines. In the United States, ASTM D4814 standard establishes the requirements of gasoline for ground vehicles with spark-ignition internal combustion engines. Gas oil (GO)/diesel is predominantly middle-distillate range hydrocarbons and is used in compression-ignition internal combustion engines. In the United States, ASTM D975 standard covers the requirements of several grades of diesel fuel suitable for various types of diesel engines.

Accordingly, in the illustrated embodiment, the intermediate liquid product 84 is fed to a distillation unit 86 to recover gasoline product 90 and a distillate product 92 (e.g., a middle distillate). In certain embodiments, kerosene/jet fuel 94 are recovered as separate streams from the distillation unit 86. The distillate product 92 (e.g., the middle distillate) contains gas oil (GO), for example biodiesel, and is substantially fully free from oxygen, sulfur, and nitrogen. In certain embodiments, the oxygen content of the distillate product 92 is less than approximately 1.50 wt %. For example, the oxygen content may be approximately 1.40 wt %, 1.25 wt %, 0.50 wt %, 0.25 wt %, or 0.10 wt % or less. In one embodiment, the sulfur content is less than 100 ppmw. For example, the sulfur content may be approximately 75 ppmw, 50 ppmw, 25 ppmw, 10 ppmw, 5 ppmw, 1 ppmw or less. Accordingly, the biodiesel obtained from the distillate product 92 is considered an ultra-low sulfur diesel (ULSD), which generally has less than 10 ppmw sulfur. Regarding the nitrogen content, in certain embodiments, the nitrogen content of the substantially fully deoxygenated C₄₊ hydrocarbon liquid is less than 1000 ppmw. For example, the nitrogen content may be approximately 750 ppmw, 500 ppmw, 250 ppmw, 100 ppmw, 75 ppmw, 50 ppmw, 25 ppmw, 10 ppmw, or 1 ppmw or less.

As discussed above, hydrocarbon liquid products such as the distillate product 92 generated from hydroprocessing of solid biomass feedstock (e.g., the solid feedstock 18) generally requires additional processing to upgrade and improve product properties such as cetane number, reduced density, reduced sulfur and/or nitrogen content, reduced benzene content (e.g., as a result of selective saturation), among others, and facilitate tailoring the overall hydrocarbon product to certain location and market specifications, among other benefits. However, the additional processing to upgrade the distillate product 92 introduces complexity to the process, while also increasing the overall cost of producing commercially viable biodiesel fuels having the desired specifications set forth by various fuel regulations. However, it has been recognized that by blending the distillate product 92 with a hydrotreated ester and/or fatty acid (HEFA), the product properties (e.g., cetane number, density) are improved without requiring additional processing to upgrade the distillate product 92. Therefore, in accordance with an embodiment of the present disclosure, the distillate product 92. The distillate product 92 may be further processed in a third stage of the hydroprocessing system 10 to upgrade the distillate product 92 into a commercially viable biodiesel fuel. In other embodiments, the distillate product 92 may be combined with other hydrocarbons (e.g., fossil-derived hydrocarbons and/or biorenewable-derived biodiesel) to yield a commercially viable biodiesel blend that does not require upgrading in the third stage.

### Solid Feedstock System

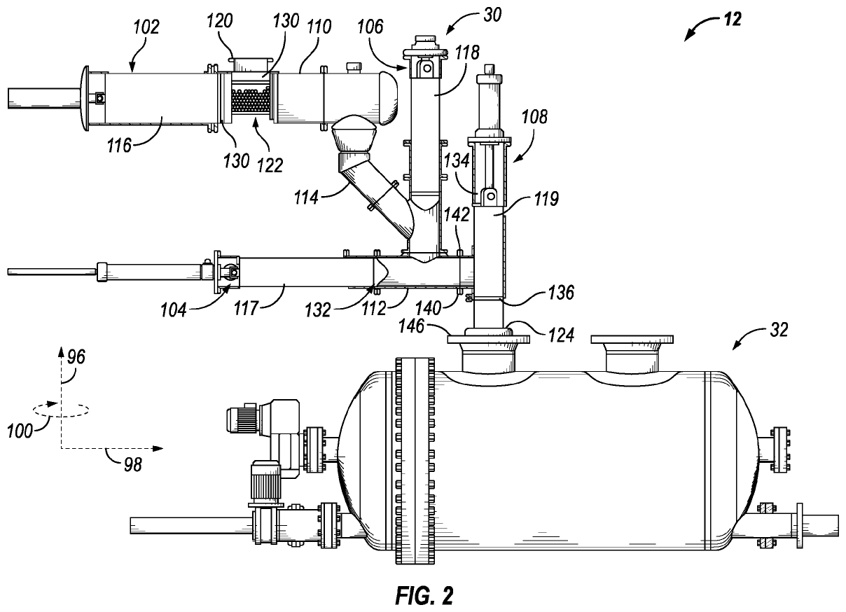

As discussed above, the solid feedstock system 12 provides the solid feedstock 18 to the reactor 14 in a manner that does not require a pressurized gas and large volume vessels compared to lock hopper feeding systems, and does not result in compaction of the solid feedstock 18. FIG. 2 illustrates an arrangement of the piston feeder 30 and the dosing tank 32 of the solid feedstock system 12, in accordance with an embodiment of the present disclosure. The solid feedstock system 12 may have an axial axis or direction 96, a radial axis or direction 98 away from axis 96, and a circumferential axis or direction 100 around the axis 96. The piston feeder 30 includes multiple pistons arranged in a manner that allow the solid feedstock 18 to move through the piston feeder 30 and into the dosing tank 32 while maintaining a desired pressure within each chamber of the piston feeder 30. For example, in the illustrated embodiment, the piston feeder 30 includes a first piston 102, a second piston 104, a third piston 106, and a fourth piston 108. The piston feeder 30 also includes a first chamber 110, a second chamber 112, and a conduit 114 extending between and fluidly coupling the chambers 110, 112. Each piston 102, 104, 106, 108 includes a respective barrel 116, 117, 118, and 119. The barrel 116, 117, 118, 119 translocates within a respective chamber to facilitated movement of the solid feedstock 18 through the piston feeder 30 and into the dosing tank 32, as discussed in further detail below.

In addition, the piston feeder 30 includes an inlet 120 positioned adjacent to and extending in the axial direction 96 away from the first piston 102 and the first chamber 110, a feed chamber 122 disposed within the first chamber 110 and fluidly coupled to the inlet 120, and an outlet 124 positioned adjacent to and extending axially 96 away from the fourth piston 108 and the second chamber 112. However, the inlet 120 and the outlet 124 may be arranged in any other suitable manner than allows a flow of the solid feedstock 18 into and out of the piston feeder 30.

At least a portion of the barrel 116 of the first piston 102 is disposed within the first chamber 110 and moves (e.g., translocates) along a length of the first chamber 110, for example, in the radial direction 98 to move the solid feedstock 18 from the first chamber 110 and into the conduit 114. Similar to the first piston 102, at least a portion of the barrel 117 of the second piston 104 is disposed within the second chamber 112 and moves (e.g., translocates) along a length of the second chamber 112 to move the solid feedstock 18 from the second chamber 112 and into the dosing tank 32. In the illustrated embodiment, a portion of the conduit 114 is slanted relative to the axial axis 96. However, in certain embodiment, the conduit 114 may be parallel to the axial axis 96.

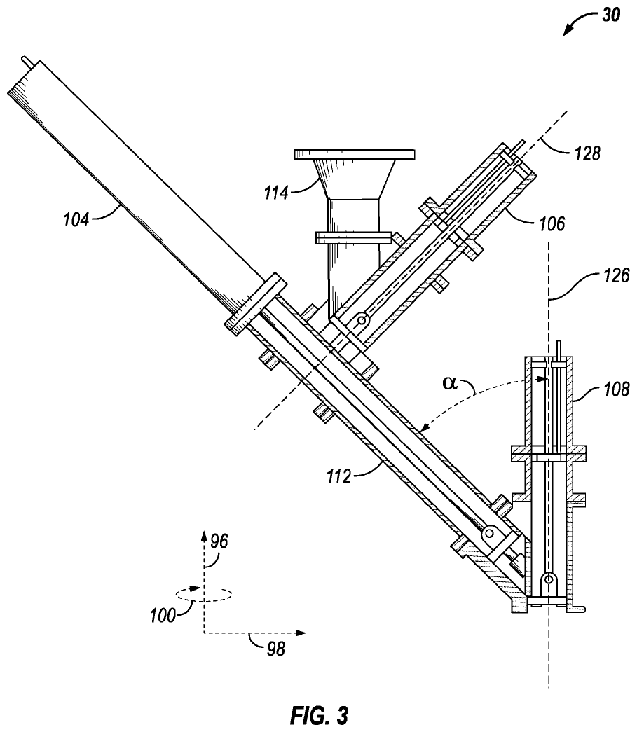

In the illustrated embodiment, the first piston 102 and the second piston 104 radially extend along the radial axis 98 and are positioned parallel to one another. The third piston 106 and the fourth piston 108 extend axially along the axial axis 96 and are parallel to one another and orthogonal to the pistons 102, 104. However, in other embodiments, the pistons 102, 104 are not positioned parallel to one another. For example, FIG. 3 illustrates an embodiment of the piston feeder 30 in which the piston 104 is oriented at an acute angle α relative to a centerline axis 126 of the piston 108 and orthogonal to a centerline axis 128 of the piston 106. Consequently, the second chamber 112 of the piston feeder 30 is also oriented at the acute angle α relative to the centerline axis 126 of the piston 108. By arranging the piston 104 and the second chamber 112 in this way, the solid feedstock may move along the second chamber 112 easily due, in part, to gravitational forces and eroding of an interior surface of the second chamber 112 may be mitigated. For example, the solid feedstock may be abrasive and scratch, or otherwise erode, the interior surface of the second chamber 112 as the barrel 117 of the piston 104 pushes the solid feedstock toward the fourth piston 108 and into the dosing tank 32. Such movement of the solid feedstock may, overtime, wear away the interior surface of the second chamber 112. In addition, the solid feedstock may lodge between the interior surface of the second chamber 112 and the outer surface of the barrel 117. As such, the barrel 117 may be unable to properly move within the second chamber 112 and transfer the solid feedstock into the dosing tank 32. The slanted, or angled, configuration of the second piston 104 and the second chamber 112 may mitigate wear of the piston feeder surfaces (e.g., the interior surface of the second chamber 112 and the outer surface of the piston 106) and lodging of the solid feedstock between the interior surface of the second chamber 112 and the outer surface of the piston 104.

Returning to FIG. 2, the outlet 124 couples (e.g., connects) the piston feeder 30 to the dosing tank 32 such that the solid feedstock 18 may be transferred from the second chamber 112 to the dosing tank 32. In operation, the first chamber 110 and the conduit 114 are maintained at ambient pressure (e.g., approximately 0.1 MPa (1 bara)) and the second chamber 112 and the dosing tank 32 are pressurized according to the pressure within the reactor 14. For example, the second chamber 112 and the dosing tank 32 may be at a pressure of between approximately 0.1 megapascal (MPa) to approximately 5 MPa (approximately 1-50 bara). As discussed in further detail below, the third piston 106 may be used to maintain the different pressures within the chambers 110, 112 and mitigate flow back of the solid feedstock 18 from the dosing tank 32 back into the piston feeder 30 due to pressure differentials between, for example, a feedstock storage tank and the dosing tank 32.

The piston feeder 30 includes various valves and seals that facilitate a flow of the solid feedstock 18 through the chambers 110, 112 and the conduit 114, and mitigate flow back of the solid feedstock 18 from the dosing tanks 32 and/or reactor 14 back into the piston feeder 30. For example, the piston feeder 30 includes a seal 130 and 132 at an end of the barrels 116, 117, respectively. The piston feeder 30 also includes pressure seals 134 and 136 at an end of the barrels 118, 119, respectively. In operation, the pressure seal 136 provides a seal between the dosing tank 32 and the second chamber 112 such that when the second chamber 112 receives the solid feedstock 18 from the first chamber 110, which is at atmospheric pressure (e.g., 0.1 MPa (1 bara)), the solid feedstock 18 in the dosing tank 32, which is at a higher pressure than the chamber 110, 112 (e.g., at a pressure of between 0.6 MPa (6 bara) and 5 MPa (50 bara)), does not flow back into the piston feeder 30. Similarly, the pressure seal 134 provides a seal between the chambers 110, 112 such that when the second chamber 112 is pressurized to equal the pressure within the dosing tank 32, the solid feedstock 18 does not flow back into the first chamber 110 and the conduit 114, which are at atmospheric pressure. Once the second chamber 112 is isolated from the first chamber 110, conduit 114, and dosing tank 32, the second chamber 112 may be filled with H₂ and pressurized to the pressure within the dosing tank 32 and the reactor 14. For example, the piston feeder 30 may have a purge valve 140 and a bypass valve 142 that allow the second chamber 112 to be filled with the H₂ and pressurized the chamber 112. During pressurization of the second chamber 112, the valves 140, 142 are open to allow the air within the chamber 112 to be displaced by the H₂. After some time, the purge valve 140 is closed and the bypass valve 142 remains open such that the chamber 112, that is filled with H₂, may be pressurized to the desired pressure. Once the second chamber 112 is at the desired pressure, the bypass valve 140 is closed and the third piston 108 moves in the axial direction 96 away from the outlet 24 to release the seal and allow fluid communication between the second chamber 112 and the outlet 124.

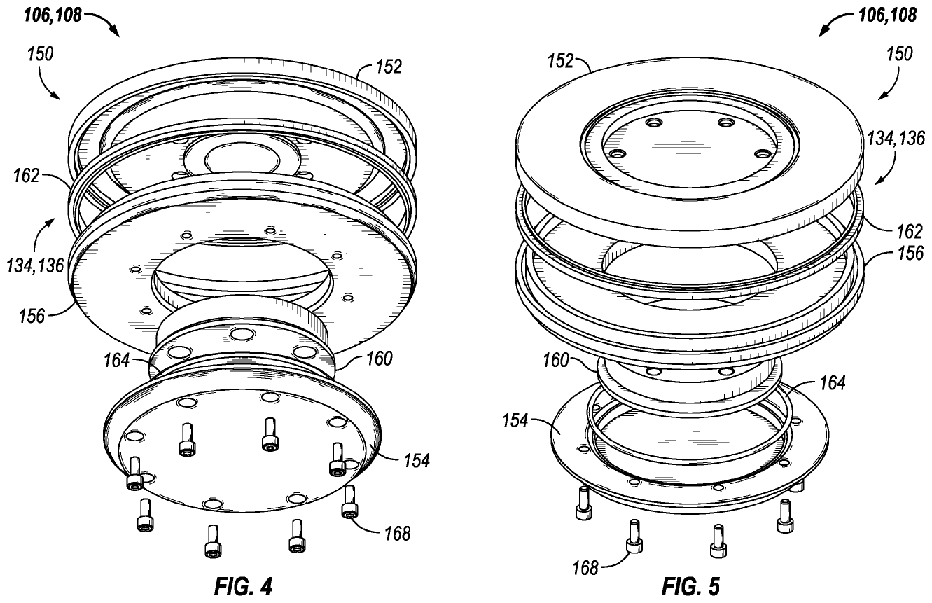

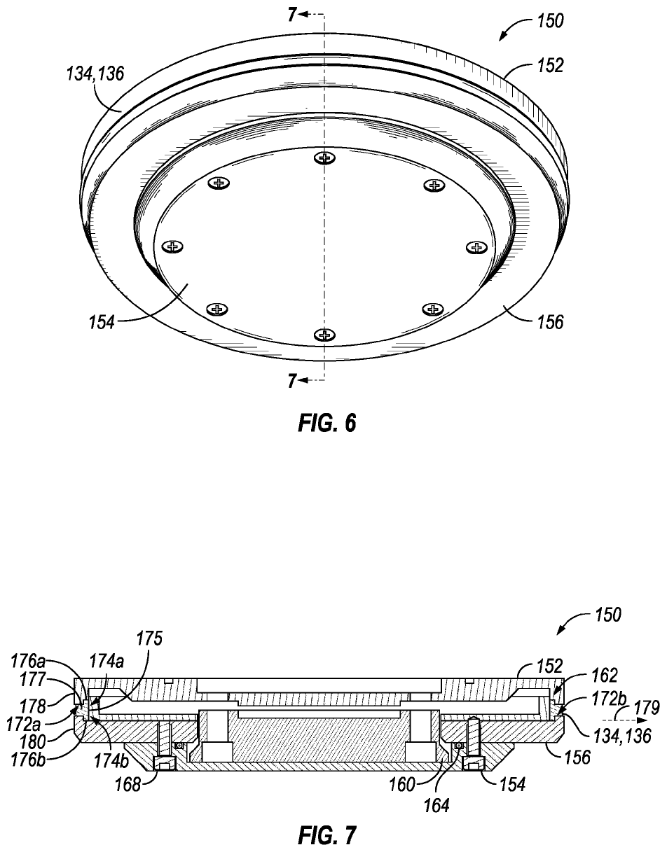

As discussed above, certain existing piston feeders use an o-ring to provide a seal and maintain pressure in a respective chamber. However, the force exerted on the o-ring by the continuous motion of the piston results in creep of the o-ring and, over time, damage. As such, the o-ring may be unable to seal and maintain the desired pressure within the respective chamber. Therefore, the pressure seal 134, 136 disclosed herein is configured in a such a way to mitigate damage resulting from the forces exerted by the piston 106, 108. For example, FIGS. 4 and 5 are perspective views of an end portion 150 of the piston 106, 108 having the disclosed pressure seal 134, 136. In addition to the pressure seal 134, 136, the end portion 150 includes a top plate 152, a bottom plate 154, a middle plate 156, and an insert 160. The pressure seal 134, 136 has an annular ring 162 that is positioned between the plates 152, 156. The end portion also includes an o-ring 164 between the bottom plate 154 and the insert 160. The plates 152, 154, 156, the insert 160, the pressure seal 134, 136, and the o-ring 164 are held together by bolts 168, thereby forming the end portion 150, as shown in FIG. 6.

FIG. 7 is a cross-sectional view of the end portion 150 along line 7-7. As shown in the illustrated embodiment, the annular ring 162 of the pressure seal 134, 136 has recesses 172 and protrusions 174 such that the annular ring 162 has a T-shaped cross-section. For example, the annular ring 162 has a first wall 175 extending between a first side 176a and a second side 176b of the annular ring 162, the second side 176b being substantially opposite (e.g., 180 degrees) from the first side 176a. The annular ring 162 also has a second wall 177 extending from and orthogonal to the first wall 175. The second wall 177 forms part of the first side 176a and the second side 176b. A portion of the first wall 175 extends (or protrudes out) from a surface of the first side 176a to form the protrusion 174a and recess 172a, and another portion of the first wall 175 extends (or protrudes out) from a surface of the second side 176b to form the protrusion 174b and recess 172b, thereby giving the annular ring 162 the T-shaped cross-sectional geometry. In certain embodiments, a flat ring may be disposed between the protrusion 174a and an inner surface of the plate 152 such that the terminal end of the protrusion 174a is not against and abuts the inner surface of the plate 152. In the illustrated embodiment, the protrusions 174 have a rectangular or square geometry. However, the protrusions 174 may have any other suitable geometry such as trapezoidal, triangular, polygonal, and combinations thereof. For example, in certain embodiments, protrusion 174a may have one cross-sectional geometry and the other protrusion 174b may have another cross-sectional geometry that is different from the cross-sectional geometry of the protrusion 174a.

As discussed in further detail below, the T-shape of the annular ring 162 facilitates coupling of the pressure seal 134, 136 to the end portion 150 and mitigates damage that may be caused by the forces exerted on the seal 134, 136 by the plates 152, 154 during operation of the piston feeder 30. For example, during operation, the second wall 177 of the seal 134, 136 expands in a linear direction 179 toward an inner surface of a respective piston chamber housing the barrels of the piston 106, 108 (e.g., the barrels 118, 119), thereby creating the seal. In addition to creating the seal, the liner movement (i.e., expansion) of the second wall 177 cleans the sealing surface during movement of the piston 106, 108 by removing feedstock that may be lodged between the barrel of the piston 106, 108 and the inner surface of the piston chamber. When the seal 134, 136 is deactivated, the second wall 177 retracts and returns to its original shape. Unlike o-ring shaped seals, the first wall 175 (e.g., the T-bar) forces the second wall 177 back to its original shape as the first wall 175 is held in place by the plates 152, 156 and is unable to move. As such, the first wall 175 pulls the second wall 177 back to its original shape and mitigates wear on the seal 134, 136 that may be caused by frictional forces exerted by the inner surface of the piston chamber onto the second wall 177. The T-shape of the annular ring 162 blocks, or otherwise mitigates, the pressure seal 134, 136 from creeping and allows it to maintain its original diameter. Additionally, narrow tolerances of the T-shape mitigate extrusion of portions of the seal 134, 136 as it is compressed during operation, which would change its shape and available material resulting in loss of sealing effectiveness. The annular ring 162 may be formed from an elastic incompressible material such that the annular ring may expand and contract to return to its original shape after application and removal of forces exerted by the plates 152. 154. 156. By way of non-limiting example, the thermoplastic material may be selected from polyurethane materials and the like. As used herein, the term “elastic incompressible material” denotes a material that maintains its density (i.e., it is incompressible) but not necessarily its shape (i.e., the material deforms) when a force is applied, and returns to its original shape when the force is removed.

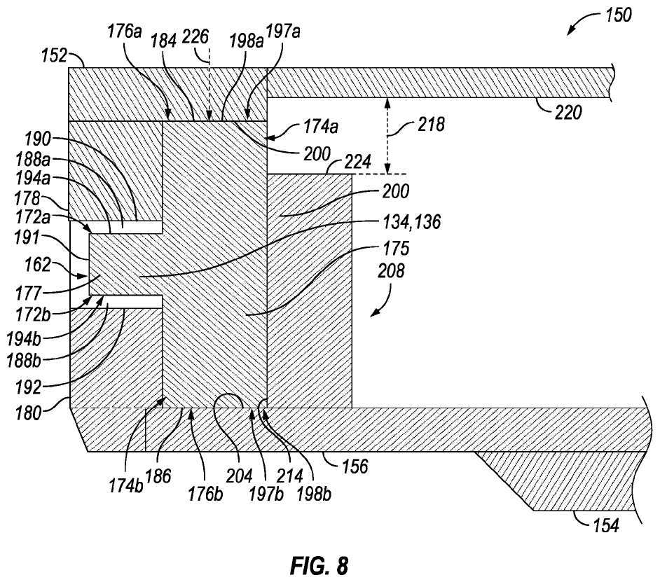

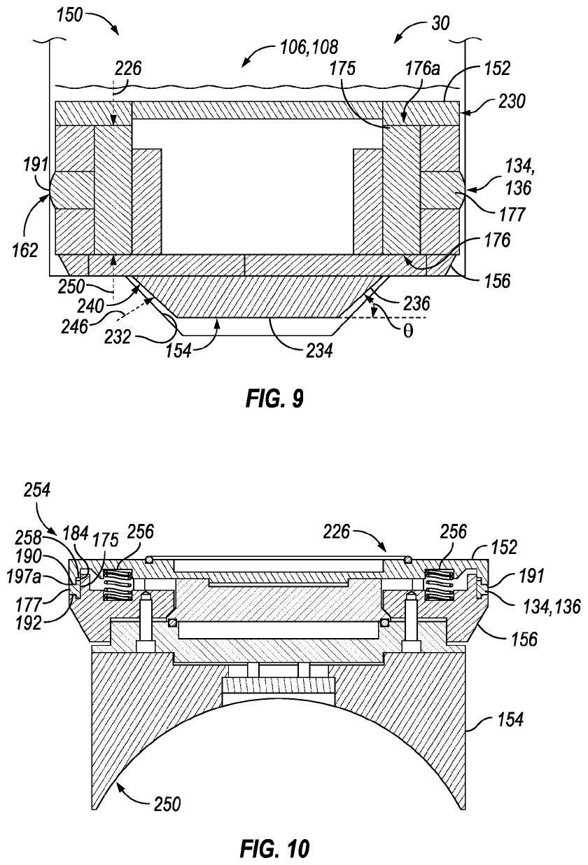

To facilitate discussion of the pressure seal 134, 136, reference will be made to FIG. 8, which is an exploded view of a section of the end portion 150. As shown in the illustrated embodiment, the T-shape cross-sectional geometry of the annular ring 162 facilitates retaining the pressure seal 134, 136 in the end portion 150. For example, the plates 152, 156 each have a lip 178, 180, respectively, that form a rim around an outer circumference of the plates 152, 156. The plates 152, 156 also have a recessed wall 184, 186 (e.g., annular recesses wall) sized and shaped to receive the protrusions 174a, 174b, respectively, of the pressure seal 134, 136. When assembled, the pressure seal 134, 136 does not about a top plate outer surface 190 and a middle plate outer surface 192. For example, as shown in the illustrated embodiment, there is a gap 188a between a first seal outer surface 194a and the top place outer surface 190, and a gap 188b between a second seal outer surface 194b and the middle place outer surface 192. The gap 188 extends circumferentially around the end portion 150 when the seal is not activated. Additionally, a terminal end 191 of the second wall 177 is positioned entirely within the lips 178, 180 such that the terminal end 191 does not protrude away from or is flush with the outer surfaces of the end portion 150. That is, the terminal end 191 is nested within the plates 152, 156. This seal configuration keeps the seal 134, 136 from rubbing against an inner surface of the respective piston feeder chamber the piston during movement of the piston, thereby mitigating creep and damage to the seal during operation. Additionally, it allows for the second wall 177 to expand and create the seal when pressure is applied by the plates 152, 156 as described in further detail below with reference to FIG. 9. Unlike the surfaces 194 of the second wall 177, portion 198a, 198b of seal outer surface 197a, 197b of the sides 176a, 176b abuts a top plate surface 200 and middle plate surface 204, respectively. That is, there is no gap between the outer surface 197 of the pressure seal 134, 136 and the respective plate surfaces 220, 204. In addition, the middle plate 156 includes an interior wall 208 adjacent to the recessed wall 186 and extending from the middle plate surface 204. An outer portion 210 of the first wall 175 abuts an outer surface 214 of the interior wall 208.

A second gap 218 between a top plate inner surface 220 and a terminal end 224 of the interior wall 208 allows for the top plate 152 to exert a force 226 on the pressure seal 134, 136 when the piston (e.g., the piston 106, 108) translocates to isolate the chamber (e.g., the second chamber 112) and/or the outlet (e.g., the outlet 124) such that a pressure differential between the dosing tank (e.g., the dosing tank 32) and piston chambers at atmospheric pressure (e.g., the first chamber 110 does not result in flow back of the solid feedstock (e.g., the solid feedstock 18) from the dosing tank back into the piston feeder (e.g., the piston feeder 30). For example, as the piston 106, 108 moves in a direction towards the outlet 124 the bottom plate 154 abuts against a terminal end of the chamber it is in causing the bottom plate 154 and the middle plate 156 to move in a direction opposite to the direction the piston 106, 108 is moving. Consequently, the gap 218 is decreased causing the top plate 152 to exert the force 226 on the pressure seal 134, 136. The bottom plate 154 also exerts a force counter to the force 226, which pushes against the pressure seal 134, 136, thereby causing a portion of the annular ring 162 to compress and pushing it towards an inner wall of the chamber, as explained in further detail below. The compression of the annular ring 162 creates a seal within the chamber and blocks fluid communication between a space of the piston feeder or chamber adjacent to (or above) the top plate 152 and a space of the piston feeder or chamber adjacent to (or below) the bottom plate 154.

For example, FIG. 9 is cross-sectional view of a portion of the piston feeder 30 having the pressure seal 134, 136 of the present disclosure in an activated configuration. In the illustrated embodiment, the end portion 150 of the piston 106, 108 is positioned within a chamber 230 of the piston feeder 30 such that the bottom plate 154 abuts against a portion of an inner chamber wall 232. The bottom plate 154 has a beveled terminal end 234 having a slanted wall 236 that forms an angle θ of between approximately 30° and 50°. A portion 240 of the beveled terminal end 234 contacts the inner chamber wall 232 such that the inner chamber wall 232 exerts a force 246 against the bottom plate 152. Consequently, the gap 218 decreases, thereby exerting the force 226 and a counter force 250 onto the pressure seal 134, 136 causing the annular ring 162 compress and the second wall 177 to expand, thereby closing the gap 188 and pushing the terminal end 191 out toward an inner surface 252 of the chamber 230 to provide the seal. The T-shape configuration of the annular ring 162, in combination with the beveled terminal end 234 of the bottom plate 154, mitigate damage to the annular ring 162 that may be caused by creep, as discussed above.

FIG. 10 illustrates an alternative embodiment of the end portion 150 of the piston 106, 108 in which the end portion includes a spring and an o-ring between the plates 152, 154. For example, in the illustrated embodiment, an end portion 254 includes a spring 256 within a void 258 that forms between the plates 152, 156 of the end portion 254. Unlike the end portion 150, the end portion 254 does not include a separate middle plate (e.g., the middle plate 156). Rather, the bottom plate 154 of the end portion 254 is combined with the middle plate (e.g. the middle plate 156) such that the bottom plate 154 and the middle plate form a single unitary structure. In the illustrated embodiment, coupled to the bottom plate 154 is a volume dispenser 255 having a concave configuration. The volume dispenser 255 facilitates movement of the solid feedstock through the piston feeder, the dosing tank, and/or the reactor.

As discussed above, the seal 134, 136 expands when activated, forcing the second wall 177 toward the inner surface of the piston chamber (e.g., the inner surface 252) to create the seal. When the seal 134, 136 is deactivated (e.g., when the seal is broken), the second wall 177 is pulled toward the first wall 175 and the seal 134, 136 returns to its original shape. The spring 256 facilitates pulling the second wall 177 toward the first wall 175 after the forces 226, 250 are released by overcoming the friction forces exerted on the second wall 177 by the surface 190, 192 of the plates 152, 156, respectively. In addition to facilitating retraction of the second wall 177 when the seal 134, 136 is deactivated, the spring 256 mitigates wear of the terminal end 191 resulting from friction forces exerted by the inner surface of the piston chamber against the terminal end 191 when the second wall 177 does not retract to its original shape once deactivated. For example, once the seal 134, 136 is deactivated, the piston 106, 108 moves in a direction away from an end of the chamber (e.g., in a direction that is substantially the same as the counter force 250). If the second wall 177 of the seal 134, 136 does not retract to its original shape, the terminal end 191 may rub against the inner surface of the chamber. This rubbing (i.e., friction) may wear the seal 134, 136 over time causing leakage and feedstock to get trapped between the piston and the inner surface of the chamber. The spring 256 may be any spring suitable for overcoming the friction forces of the seal 134, 136. The spring 256 has an annular configuration and may be made from materials such as, but not limited to, steel, metal alloys, or the like. The end portion 254 may have any number of springs 256. For example, the end portion 254 may have 1, 2, 3, 4, 5, 6, 7, 8, 9, 10, or more springs 256.

In addition to the spring 256, the end portion 254 includes a backup ring 258 between the recessed wall 184 and the outer surface 197a of the pressure seal 134, 136. The backup ring 258 mitigates extrusion of the first wall 175, for example, when there is a gap between the recessed wall 258 and the outer surface 197a of the seal 134, 136. The backup ring 258 may be made of any suitable material with sufficient durability and elastomeric properties to withstand the forces 226, 250 and block extrusion of the first wall 175 during operation of the piston feeder. By way of non-limiting example, the backup ring 258 may be a nylon ring or the like.

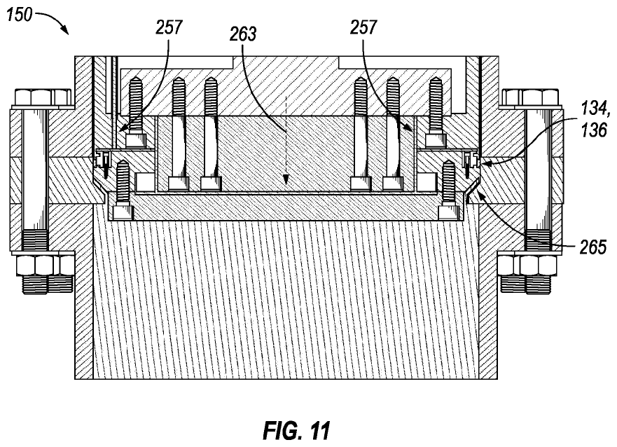

FIG. 11 illustrates another embodiment of the end portion 150 of the piston 106, 108 in which the end portion includes a pressure assisted seat 253. The pressure-assisted seat 253 works by balancing of process pressure 255 (e.g., the pressure below the end portion 150) against seat pressure 257 (e.g., the pressure inside of the piston for de-activating the seal function). The seat pressure 257 is maintained higher than the process pressure 255. For example, the seat pressure 257 is maintained at between approximately 0.5% and 25% higher than the process pressure 255. By way of non-limiting example, the seat pressure 257 may be between approximately 1 and 15 bar higher than the reactor pressure, and the process pressure 255 may be between approximately 1 and 10 bar higher than reactor pressure. In this way, it is ensured that the pressure on the seal 134, 136 may be released when the piston (e.g., the piston 106, 108) is retracted independently of the operating pressure. An advantageous aspect of this design is that having a higher seat pressure 257 compared to the process pressure 255 secures the retraction of the seal 134, 136 when removing pressure from the pressure-assisted seat 253 when the piston moves away from the outlet (e.g., the outlet 124) of the piston feeder or of the chamber in which the piston is housed. Additionally, bearings may be positioned adjacent to seal 134, 136 (e.g., adjacent to and abutting the first wall 175 of the T-shaped annular ring 162) to control the concentricity of the pressure-assisted seat 253. The bearings ensure that the seat can move axially without damaging surfaces of the end portion 150 and the piston chamber. The bearings 259 may be made from a material having a hardness that is different from a hardness of the pressure-assisted seat 253. By way of non-limiting example, the bearings may be bronze or any other material that is softer than the material of the pressure-assisted seat 253. A central part 263 sets the precompression of the seal 134, 136 when no pressure is set on a metal-metal seat 265. The central part 263 of the end portion 150 of the piston is pressurized by an external source of inert gas though a pipe in the piston. By maintaining a higher pressure in the piston than in the process it is ensured that all leaks will be from the inside and out and thereby avoiding dust or foreign matters from entering the moving parts of the seat construction. For example, the higher pressure in the metal-metal seat 265 compared to the process pressure ensures that dust does not accumulate and, in case there is a leak due to a damaged O-ring, gas will not flow into the equipment which may otherwise cause damage and impact performance.

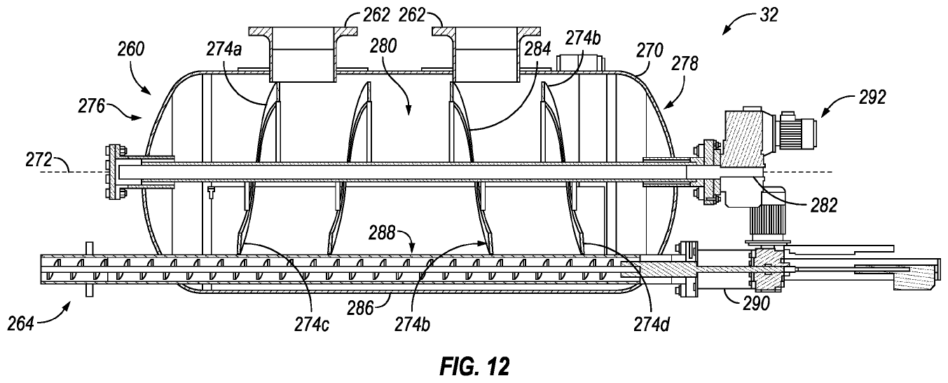

As discussed above, the disclosed piston feeder (e.g., the piston feeder 30) provides solid feedstock (e.g., the solid feedstock 18) to the dosing tank 32. The dosing tank 32 may include additional features such as agitators and screw conveyors that keep the solid feedstock 18 in motion, mitigate compaction, and facilitate dosing the solid feedstock 18 into the reactor 14. FIG. 12 is a cross-sectional view of an embodiment of the dosing tank 32. The dosing tank 32 includes the body 260, inlets 262, and outlet 264. While in the illustrated embodiment, the dosing tank 32 has a single outlet 264, the dosing tank 32 may have multiple outlets. The body 260 defines a housing 270 (e.g., vessel) of the dosing tank 32 that contains a desired volume of feedstock (e.g., the solid feedstock 18). For example, the housing 270 may contain a volume of solid feedstock that is between approximately 10 m³ to 130 m³. As such, dimensions of the housing 270 may be between approximately 2 m (meters) diameter×4 m length and 4 m diameter×10 m length. However, as should be appreciated, the housing 270 may be any size suitable for containing the desired amount of solid feedstock. The housing 270 has a longitudinal axis 272 that extends from a first end 276 to a second end 278 of the dosing tank 32. In embodiments having multiple outlets 264, one or more outlets 264 are positioned at the first end 276 and one or more outlets 264 are positioned on the second end 278. The outlets 264 may feed the solid feedstock (e.g., the solid feedstock 18) into the reactor (e.g., the reactor 14) symmetrically (e.g., each outlet feeding the solid feedstock into the reactor simultaneously) or in series (e.g., one outlet feeds the solid feedstock into the reactor followed by the other outlet feeding the feedstock into the reactor). Each outlet 264 may dose the same or different amounts of the solid feedstock into the reactor. In certain embodiments, each outlet 264 may be fluidly coupled to separate reactors such that one dosing tank 32 may feed the solid feedstock into multiple reactors.

As shown in FIG. 12, along the longitudinal axis 272 are multiple agitators 274 that move the solid feedstock entering the housing 270 toward a center 280. The agitators 274 include a shaft 282 having a plurality of blades 284 that maintain movement of the solid feedstock 18 within the dosing tank 32. In operation, the agitators 274a and 274c move in a first direction along the longitudinal axis 272 such that the respective blades 284 move a first portion of the solid feedstock 18 toward the center 282, and the agitators 274b and 176d move in a second direction opposite the first direction along the longitudinal axis 272 such that the respective blades 284 move a second portion of the solid feedstock 18 toward the center 280.

The housing 270 also includes one or more troughs 286 into which the solid feedstock enters through an opening 288 at the center 280 of the housing 270. The troughs 286 extend along the longitudinal axis 272 from the first end 276 to the second end 278 and terminate at the respective outlet 264. In embodiments having multiple troughs 286, the troughs 286 are adjacent to one another and separated by a partition such that the solid feedstock in one trough 286 is separated from the solid feedstock in an adjacent trough 286. Each trough 286 includes a solid feed transport device 290 that moves and doses the solid feedstock in the trough 286 to the reactor (e.g., the reactor 14). By way of non-limiting example, the solid feed transport device 290 is a screw conveyor type, pneumatic transport system, or any other suitable solid feed transport device. The dosing tank 32 may include one or more control device 292 that control and facilitate movement of the agitator 274 and the solid feed transport device 290. The agitators 274 and the solid feed transport device 290 operate independently from one another. Therefore, the agitator 274 and the solid feedstock transport device 290 each have their own control device 292. However, in certain embodiment, the agitator 274 and the solid feedstock transport device 290 are independently operated using the same control device 292. As should be appreciated, the dosing tank 32 may be used in combination with the disclosed piston feeder. It may be positioned upstream or downstream of the piston feeder. In certain embodiments, the dosing tank 32 may be integral with the piston feeder. In other embodiments, the dosing tank 32 is a standalone unit that is separate from and removably coupled to the piston feeder. By having the dosing tank 32 as a standalone unit, it may be retrofit into existing reactor system and allows flexibility in adjusting the solid feedstock feeding system configuration (e.g., move the dosing tank from a downstream position to an upstream position relative to the piston feeder, remove the dosing tank from a solid feedstock feeding system already in place, or add the dosing tank to a solid feedstock feeding system already in place).

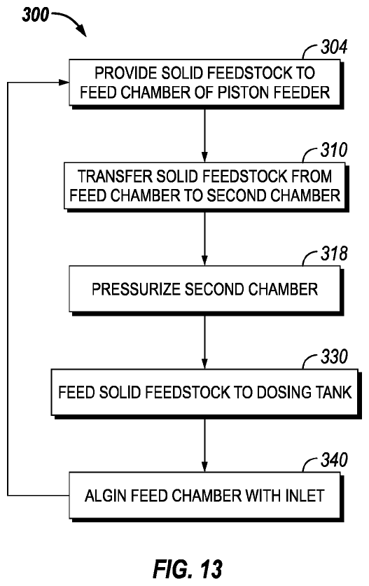

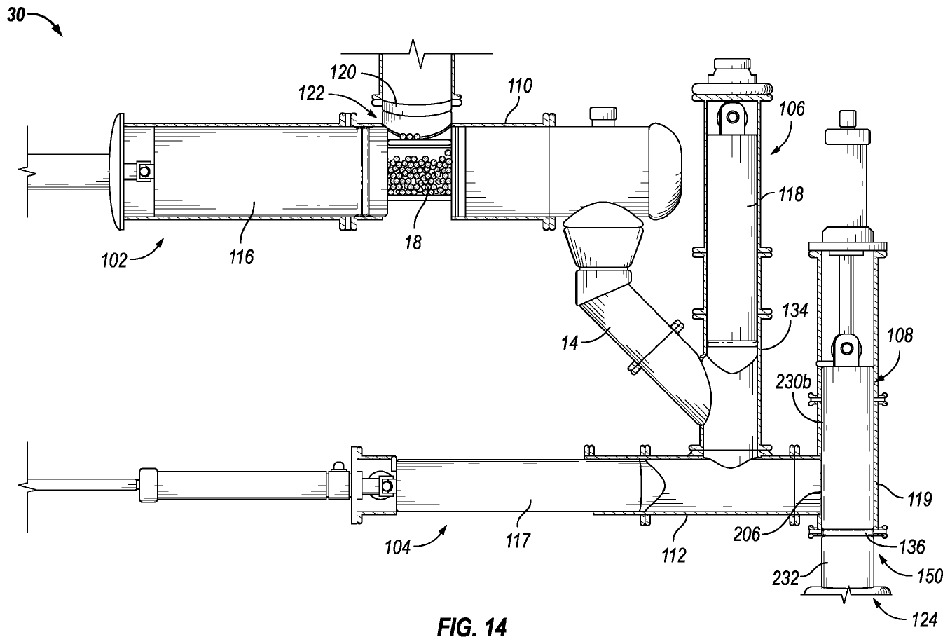

Present embodiments also include a method of feeding a solid feedstock (e.g., the solid feedstock 18) to a reactor (e.g., the reactor 14). For example, FIG. 13 is a flow diagram of a method 300 that may be used to feed the solid feedstock into the reactor using the disclosed piston feeder (e.g., the piston feeder 30), while also avoiding flow back of the solid feedstock from the dosing tank (e.g., the dosing tank 32) back into the piston feeder. To facilitate discussion of the acts of the method 300, reference will be made to FIG. 14-18. The method 300 includes providing the solid feedstock to a first chamber of the piston feeder at ambient pressure (block 304).

For example, with reference to FIG. 14, the piston feeder 30 receives the solid feedstock 18 from a solid feedstock storage tank through the inlet 120. As shown in the illustrated embodiment, the inlet 120 is fluidly coupled to the feed chamber 122. The feed chamber 122 is aligned with the inlet 120 and receives the solid feedstock 18 from the solid feedstock storage tank disposed upstream of the piston feeder 30. In the illustrated embodiment, the fourth piston 108 is positioned such that the chambers 110, 112, 122 and the conduit 114 are isolated from the outlet 124 and the dosing tank (e.g., the dosing tank 32) to avoid flow back of the solid feedstock 18 that may be in the dosing tank. For example, as discussed above the dosing tank is at a pressure of between approximately 0.6 MPa (6 bara) and 5 MPa (50 bara), which is the pressure within the reactor (e.g., the reactor 14). In contrast, the pressure within the chambers 110, 112, 122 and the conduit 114 is at ambient (e.g., approximately 0.1 MPa (1 bara)). The pressure differential between the piston feeder 30 and the dosing tank may cause flow black of the solid feedstock 18 back into the piston feeder 30 if an exit 206 of the second chamber 112 is not blocked and isolated from the outlet 124. Therefore, while in this position, the end portion 150 of the fourth piston 108 abuts the inner chamber wall 232 of the chamber 230b, thereby exerting a force on the pressure seal 136 causing it to compress, which forces it out against an inner surface of the chamber 230b. In this way, the pressure seal 136 provides a seal and isolates the outlet 124 from the chambers 110, 112, 122 and the conduit 114 to maintain the pressuring at the outlet 124 substantially the same as the pressure within the dosing tank.

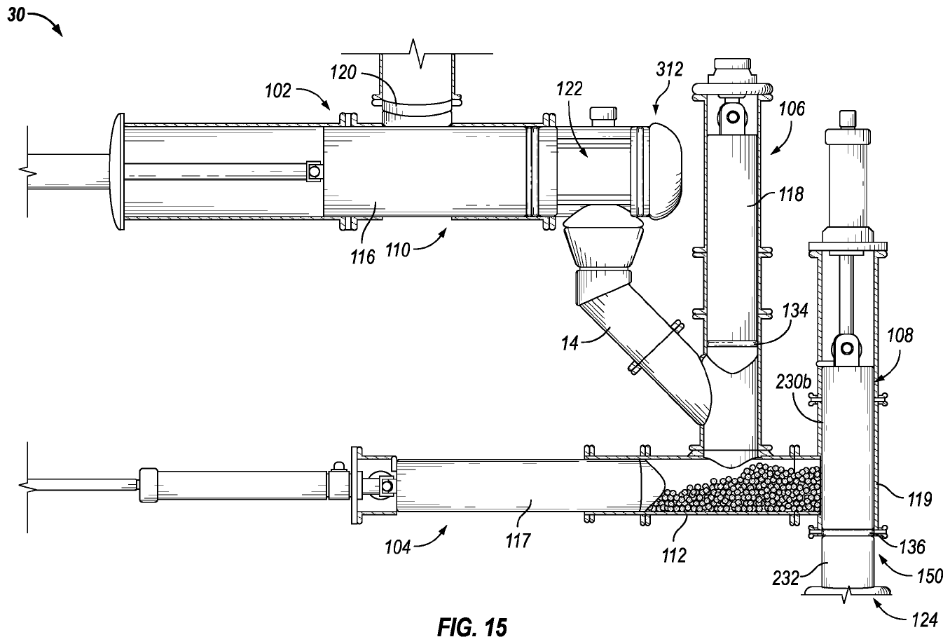

Returning to FIG. 13, the method 300 also includes transferring the solid feedstock from the feed chamber into the second chamber (block 310). For example, as shown in FIG. 15 the first piston 102 moves towards a terminus 312 of the first chamber 110 to align the feed chamber 122 with an opening 316 of the conduit 114. Once the feed chamber 122 is aligned with the opening 316, the solid feedstock 18 flows through the conduit 114 and into the second chamber 112. The fourth piston 108 remains in place to continue isolating the outlet 124 and blocking fluid communication between the chambers 110, 112, 122 and the conduit 114 and the dosing tank, thereby mitigating flow back of the solid feedstock 18 already in the dosing tank.

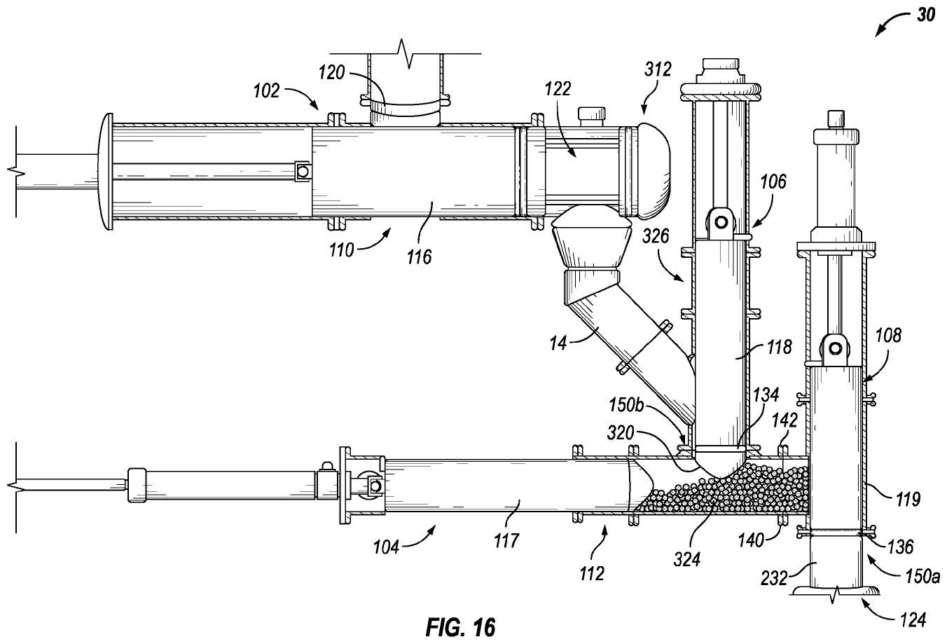

Once again returning to FIG. 13, following transfer of the solid feedstock to the second chamber in accordance with the acts of block 310, the method 300 includes pressurizing the second chamber (block 318). For example, the third piston 106 moves toward the second chamber 112, thereby blocking fluid communication between the chambers 110, 122 and the conduit 114 and the second chamber 112, as shown in FIG. 16. The second chamber 112 is isolated from the conduit 114 (and anything upstream of the conduit 114) and the outlet 124 of the piston feeder 30. Similar to the fourth piston 108, the end portion 150b of the third piston 106 abuts an inner wall 320 of a chamber inlet 324 associated with the second chamber 112, thereby exerting a force on the pressure seal 134 causing it to compress, which forces it out against an inner surface of a second conduit 326 that houses the barrel 118 of the third piston 106. The fourth piston 108 remains in position blocking fluid communication between the second chamber 112 and the outlet 124. In this way, the pressure seal 134 provides a seal and isolates the second chamber 112 from the conduit 114 and upstream of the conduit 114, and the pressure seal 136 seals and isolates the second chamber 112 from the outlet 124 to allow the second chamber 112 to be pressurized to a pressure that is substantially the same as the pressure within the dosing tank.

For example, a pressure of the second chamber 112 is at ambient. Therefore, the second chamber 112 is pressurized according to block 312 of the method 300 such that the pressure within the second chamber 112 is approximately equal to the pressure within the dosing tank. Pressurizing the second chamber 112 before feeding the solid feedstock 18 into the dosing tank mitigates flow back of the solid feedstock 18 within the dosing tank that may be caused due to the pressure differential between the second chamber 112 and the dosing tank. As discussed above, the second chamber 112 includes the bypass valve 140 through which H₂ gas may be injected into the second chamber 112. The purge valve 142 is opened such that the air within the second chamber 112 may be displaced by the H₂ gas. Once the air within the second chamber 112 is displaced, the purge valve 142 is closed and the H₂ gas continues to fill the second chamber 112 until the desired pressure is reached. For example, the dosing tank may be at a pressure of between approximately 0.6 MPa (6 bara) and 5 MPa (5 bara). Accordingly, the second chamber 112 is pressurized to a pressure of 0.6 MPa (6 bara) and 5 MPa (5 bara).

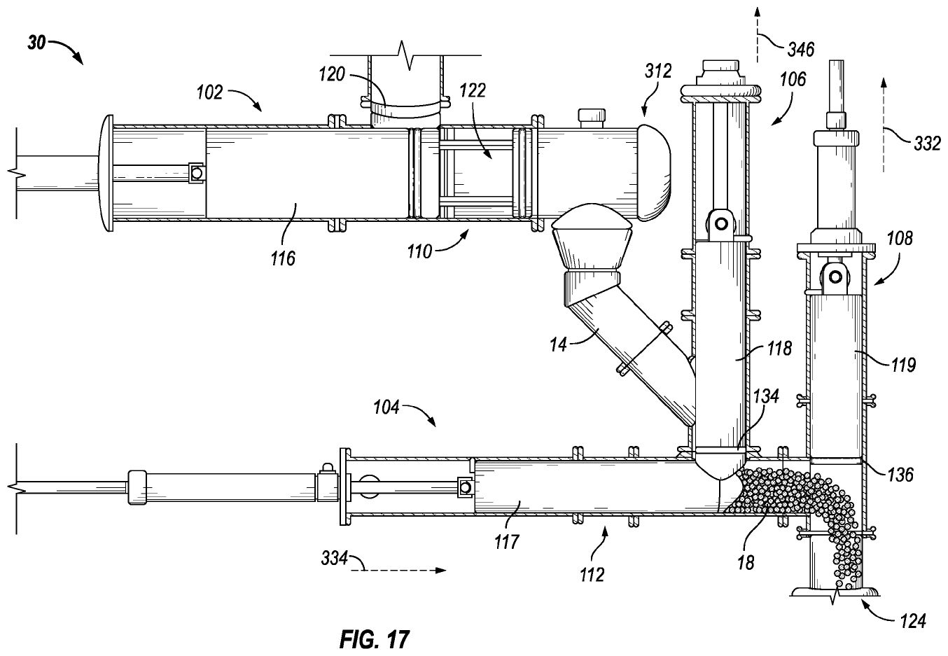

Returning to FIG. 13, the method includes feeding the solid feedstock to a dosing tank (block 330). To feed the solid feedstock 18 into the dosing tank (e.g., the dosing tank 32), the fourth piston 108 moves away from the outlet 124 while the third piston 106 remains in place to maintain the second chamber 112 isolated from the first chambers 110, 122 and the conduit 114, as shown in FIG. 17. Movement of the fourth piston 108 in the direction 332 releases the force (e.g., the forces 226, 250) from the pressure seal 136, which opens and allows fluid communication between the second chamber 112 and the dosing tank via the outlet 124. The barrel 117 of the second piston 104 moves within the second chamber 112 in a direction 334 toward outlet 124 to move the solid feedstock 18 into the dosing tank. As should be noted, the pistons 104, 108 may move simultaneously or in series. For example, in one embodiment, the third piston 106 moves in the direction 334 as the fourth piston 108 moves in the direction 332. In other embodiments, the fourth piston 108 moves in the direction 332 first to allow fluid communication between the second chamber 112 and the outlet 124, followed by movement of the second piston 104 in the direction 334 to feed the solid feedstock 18 into the dosing tank.

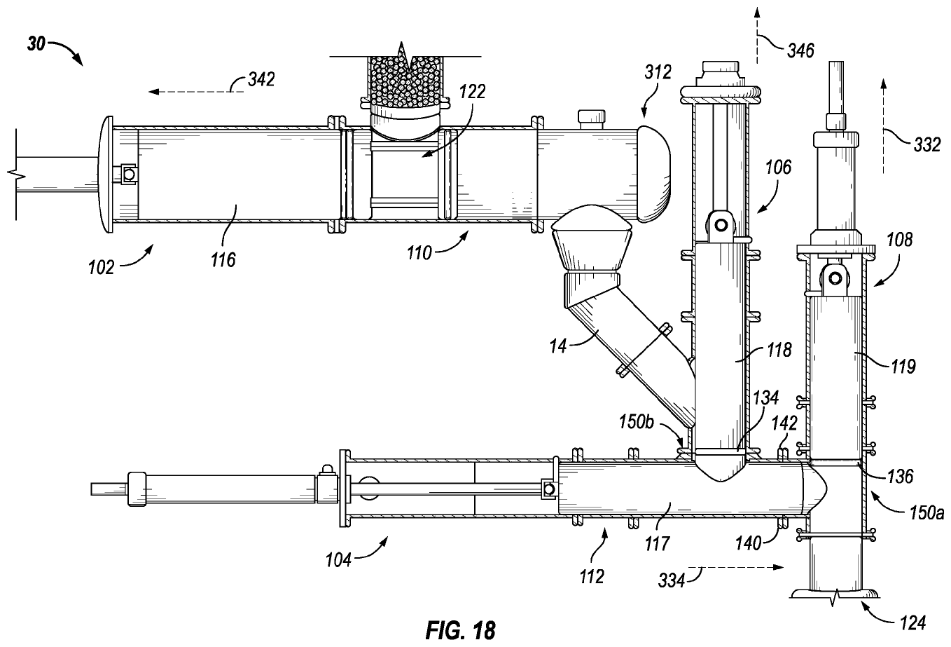

Once the solid feedstock 18 is fed to the dosing tank, the piston feeder 30 may receive another batch of the solid feedstock 18. For example, returning to FIG. 13, the method 300 includes aligning the feed chamber with the inlet of the piston feeder (block 340). The step may be done after or during the acts of block 330. In certain embodiments, the acts of block 340 may be done simultaneously with the acts of block 318. During alignment of the feed chamber 122 and the inlet 124, the first piston 102 moves in a direction 342 away from the terminus 312 of the first chamber 110 and toward the inlet 124 (see FIG. 18). The pistons 104, 106, 108 remain in place to keep the first chamber 110 and the conduit 114 isolated from the second chamber 112, the outlet 124, and the dosing tank. In this way, flow back of the solid feedstock 18 in the dosing tank may be mitigated.

Following alignment of the feed chamber 122 with the inlet 124, the solid feedstock 18 is provided to the feed chamber 122 in accordance with the acts of block 304. The method 300 may be repeated for each batch of solid feedstock that is fed to the dosing tank. Before, during, or after each batch of solid feedstock 18 is provided to the feed chamber 122, the second piston 104 may move away from the fourth piston 108 and the outlet 124 in a direction substantially opposite from the direction 334 and the fourth piston 108 may move toward the outlet 124 in a direction substantially opposite from the direction 332. The third piston 106 remains in place such that the second chamber 112 remains isolated from the first chamber 110 and the conduit 114. The configuration of the pistons 106 and 108 block fluid communication between the second chamber 112 and the first chamber 110 and the outlet 124, respectively. While in this configuration, the purge valve 142 may be opened to release the H₂ and depressurized the second chamber 112. Once depressurized, the third piston 106 may move away from the second chamber 112 in a direction 346 to allow fluid communication between the first chamber 110 and the second chamber 112 (see FIG. 18). As should be noted, based on the arrangement of the pistons 106 and 108, the directions 332, 346 may be the same or different.

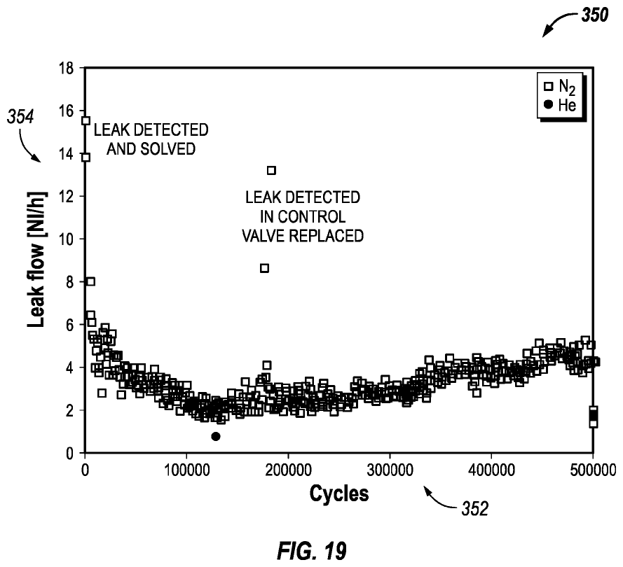

A piston having the seal and end portion configuration disclosed herein was tested for leakage. The leakage test was performed by pressurizing the piston and maintaining the pressure over a period of time. A reduction in pressure was measured during that time period, and the leakage rate was determined from the rate of pressure decrease. For example, the piston was pressurized to 41.5 bar. After 45 seconds, the pressure was measured every second for 300 seconds. A slope of a liner regression of the measured pressure was determined and the leak flow was calculated from the slope. The leakage test provides a good indication as to whether the piston maintains a seal for a desired number of cycles. The experimental setup included a piston having an end portion similar to that shown FIG. 10 and disposed in a housing. The piston was moved in cycles, each cycle including a downward movement (e.g., toward a sealing area adjacent to an outlet/terminal end of the housing) to activate the seal (e.g., cause the seal to linearly expand) and an upward movement (e.g., away from the sealing area and toward a housing opening opposite to the terminal end) to deactivate the seal (e.g., cause the seal to linearly retract). A pressure vessel pressurized with inert gas (e.g., nitrogen (N₂) or helium (He)) was positioned below the piston to measure the sealing ability of the seal. A pressure of the pressure vessel was observed for a period of time to estimate a leak rate of the inert gas and changes to the leak rate during the test. FIG. 19 is a plot 350 of number of cycles 352 as a function of leak flow 354 in normal liters/hour (NL/h) of a piston having the spring loaded end portion and seal disclosed herein (e.g., as shown in FIG. 10). As shown in the illustrated embodiment, the end portion and seal configuration disclosed herein maintained the seal for over 500,000 cycles without degradation and/or wear of the seal. The leakage flow was maintained between approximately 1 NL/h and approximately 6 NL/h, which is within specifications, and remained fairly steady throughout the 500,000 cycles. Conventional o-ring type seals that do not have the T-bar configuration of the seal disclosed herein begin to degrade/wear after approximately 20 cycles. In contrast the seal disclosed herein may go through 500,000 cycles or more without any observable degradation/wear and changes in leak rate.

As discussed above, the solid feedstock system disclosed herein may be used to provide a solid feedstock (e.g., biomass) to a reactor (e.g., a hydroprocessing reactor) in a manner that does not require large vessels and pressurized gas compared to lock hopper feeding systems used in commercial applications. The disclosed system and methods may also mitigate compaction of the solid feedstock that may affect the overall efficiency of hydroprocessing techniques and cost. The disclosed system and method use a unique configuration of pistons that transfer the feed through different chambers and into a dosing tank. Certain pistons of the piston feeder provide a seal that isolates chambers to facilitate pressurizing and mitigate flow back of the solid feedstock back into the piston feeder. The disclosed seal is designed in such a manner that mitigates damage caused by creep that may result in undesirable leakage and flow back of the solid feedstock from the dosing tank to the piston feeder. Additionally, the terminal end of the pistons having the disclosed seal have a beveled terminus such that the force applied by the terminus of the piston to the seal minimizes damage to the seal overtime.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes that come within the meaning and range of equivalency of the claims are to be embraced within their scope.

We claim:

1. A system for hydroprocessing of a solid feedstock, comprising:
a hydropyrolysis reactor having one or more inlets configured to receive the solid feedstock and to generate a product stream comprising partially deoxygenated hydropyrolysis product, H₂O, H₂, CO₂, CO, C₁-C₃ gases, char, and fines, wherein the hydropyrolysis reactor comprises one or more deoxygenation catalysts;
a solid feedstock feeding system disposed upstream from and fluidly coupled to the hydropyrolysis reactor, wherein the solid feedstock feeding system comprises a piston feeder comprising an inlet, an outlet, at least one piston disposed between the inlet and the outlet, wherein the at least one piston comprises:
a chamber; and
a barrel disposed in and configured to translocate within the chamber, wherein the barrel comprises a terminal end having a seal, and wherein the seal comprises an annular ring having a first wall and a second wall, wherein the second wall is orthogonal to and extends from the first wall such that a first portion of the first wall protrudes away from the second wall in a first direction and a second portion of the first wall protrudes away from the second wall in a second direction that is substantially opposite from the first direction.

2. The system of claim 1, wherein the terminal end comprises a first plate, a second plate, and a third plate, wherein the third plate forms the terminus of the terminal end, wherein the seal is disposed between the first plate and the second plate, and wherein the terminal end is configured to apply one or more forces on the seal to push at least a portion of the seal toward an inner surface of the chamber.

3. The system of claim 2, wherein the first plate comprises a first surface, a first recessed wall, and a lip adjacent to the first recessed wall, the first recessed wall is circumferentially around the first surface and the first lip is around a circumference of the first plate, and wherein the second plate comprises a second surface, a second recessed wall, a second lip, and an interior wall extending from the second surface and positioned parallel to the second lip, the second recessed wall is disposed between the second lip and the interior wall and is circumferentially around the second surface.

4. The system of claim 3, wherein the first portion of the first wall of the seal is disposed within the first recessed wall, the second portion of the first wall of the seal is disposed within the second recessed wall, the first wall abuts the interior wall, and the second wall is disposed between the first lip of the first plate and the second lip of the second plate.

5. The system of claim 2, wherein the third plate has a beveled end, and wherein an angle of the bevel is between approximately 35° and 50°.

6. The system of claim 2, wherein the seal is an elastic incompressible material.

7. The system of claim 2, wherein a cross-sectional geometry of the seal is T-shaped.

8. The system of claim 2, comprising a second piston disposed upstream from the at least one piston, wherein the second piston comprises a second chamber and a second barrel disposed and configured to translocated within the second chamber, wherein the second barrel comprises a second terminal end having a top plate, a middle plate, a bottom plate, and a second seal disposed between the top plate and the middle plate, and wherein the second seal has a cross-sectional geometry that is T-shaped.

9. The system of claim 2, comprising a dosing tank disposed downstream from and fluidly coupled to the piston feeder, wherein the dosing tank comprises a housing having one or more inlets, and one or more outlets.

10. The system of claim 9, wherein at least one inlet of the one or more inlets is fluidly coupled to the outlet of the piston feeder and configured to receive the solid feedstock from the piston feeder, and wherein the at least one piston is positioned adjacent to the one or more inlets of the dosing tank and is configured to isolate a portion of the piston feeder from the dosing tank.

11. The system of claim 1 comprising a hydroconversion reactor disposed downstream from and fluidly coupled to the hydropyrolysis reactor, wherein the hydroconversion reactor is configured to receive the product stream, wherein the partially deoxygenated hydropyrolysis product in the product stream undergoes hydroconversion to generate a vapour phase product comprising substantially fully deoxygenated hydrocarbon product, H₂O, CO, CO₂, and C₁-C₃ gases.

12. A system for hydroprocessing of a solid feedstock, comprising:
a hydropyrolysis reactor having one or more inlets configured to receive the solid feedstock and configured to generate a product stream comprising partially deoxygenated hydropyrolysis product, H₂O, H₂, CO₂, CO, C₁-C₃ gases, char, and fines;
a hydroconversion reactor disposed downstream from and fluidly coupled to the hydropyrolysis reactor, wherein the hydroconversion reactor is configured to receive the product stream, wherein the partially deoxygenated hydropyrolysis product in the product stream undergoes hydroconversion in the hydroconversion reactor to generate a vapour phase product comprising substantially fully deoxygenated hydrocarbon product, H₂O, CO, CO₂, and C₁-C₃ gases; and
a solid feedstock feeding system disposed upstream from and fluidly coupled to the hydropyrolysis reactor, wherein the solid feedstock feeding system comprises a piston feeder comprising an inlet, an outlet, at least one piston disposed between the inlet and the outlet, wherein the at least one piston comprises a barrel disposed in and configured to translocate within a chamber and comprising a seal on a terminal end, wherein the seal comprises an annular ring having a T-shaped cross-sectional geometry.

13. The system of claim 12, wherein the seal is disposed between a first plate and a second plate forming part of the terminal end, and wherein at least a portion of the seal is configured to protrude out from an exterior surface of the first and second plates when one or more forces are applied to the terminal end and to retract when the one or more forces are removed from the terminal end.

14. The system of claim 12, wherein the terminal end of the barrel has a beveled end.

15. The system of claim 14, wherein an angle of the bevel is between approximately 35° and 50°.

16. The system of claim 12, wherein the seal is an elastic incompressible material.

17. The system of claim 12, comprising a dosing tank disposed between and fluidly coupled to the piston feeder and the hydropyrolysis reactor.

18. The system of claim 17, wherein the dosing tank comprises a housing having one or more inlets, and one or more outlets, wherein at least one inlet of the one or more inlets is fluidly coupled to the outlet of the piston feeder and configured to receive the solid feedstock from the piston feeder, and wherein the piston is positioned adjacent to the one or more inlets of the dosing tank and is configured to isolate a portion of the piston feeder from the dosing tank.

19. The system of claim 12, comprising a second piston disposed upstream from the piston, wherein the second piston comprises a second barrel disposed and configured to translocated within a second chamber, wherein the second barrel comprises a second terminal end having a second seal.

20. The system of claim 19, wherein the second seal has a cross-sectional geometry that is T-shaped.
